(19) United States
(12) Patent Application Publication
(10) Pub. No.: US 2023/0396854 A1
(43) Pub. Date: Dec. 7, 2023

(54) MULTILINGUAL CAPTIONS

(71) Applicant: Apple Inc., Cupertino, CA (US)

(72) Inventors: Christopher J. SANDERS, San Jose, CA (US); Nitigarn SIRIPANICH, Singapore (SG)

(21) Appl. No.: 18/327,844

(22) Filed: Jun. 1, 2023

Related U.S. Application Data
(60) Provisional application No. 63/365,869, filed on Jun. 5, 2022.

(51) Int. Cl. H04N 21/488; H04N 21/485

(52) U.S. Cl. CPC H04N 21/4884; H04N 21/4856

(57) ABSTRACT

In some embodiments, an electronic device displays subtitles, via a user interface, for a content item, and in some embodiments forgoes display of subtitles according to language settings, including preferred languages and a region of a respective user.

### CROSS-REFERENCE TO RELATED APPLICATIONS

This application claims the benefit of U.S. Provisional Application No. 63/365,869, filed Jun. 5, 2022, the content of which is incorporated herein by reference in its entirety for all purposes.

### FIELD OF THE DISCLOSURE

This disclosure relates generally to displaying subtitles or forgoing display of subtitles for content items according to language settings of a user.

### BACKGROUND OF THE DISCLOSURE

User interaction with electronic devices has increased significantly in recent years. These devices can be devices such as computers, tablet computers, televisions, multimedia devices, or mobile devices. Sometimes a user may wish to consume content items associated with audio tracks in various languages. The user may therefore desire efficient ways for consuming the content items according to certain language settings (e.g., preferred languages or a region of a user).

### SUMMARY OF THE DISCLOSURE

In some circumstances, an electronic device (e.g., a set top box) is configured to accept user input via an input device (e.g., a mobile device separate from the electronic device) related to language settings and can display subtitles for content items via one or more user interfaces of a display generation component (e.g., a television screen). Providing efficient ways of displaying or forgoing display of subtitles according to language settings may improve a user's experience with the electronic device and/or input device and decrease user interaction time, which is particularly important where the input devices are battery-operated.

Some embodiments described in this disclosure are directed to ways of displaying or forgoing display of subtitles for content items based on preferred language settings of respective users. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a multifunction device with a touch-sensitive display in accordance with some embodiments of the disclosure.

FIG. 1B is a block diagram illustrating exemplary components for event handling in accordance with some embodiments of the disclosure.

FIG. 2 illustrates a multifunction device having a touch screen in accordance with some embodiments of the disclosure.

FIG. 3 is a block diagram of an exemplary multifunction device with a display and a touch-sensitive surface in accordance with some embodiments of the disclosure.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIGS. 5A-5C illustrate block diagrams of exemplary architectures for devices according to some embodiments of the disclosure.

FIGS. 6A-6P illustrate exemplary ways of displaying subtitles for content items based on language settings in accordance with some embodiments of the disclosure.

FIG. 7 is a flow diagram illustrating a method of displaying subtitles for content items based on language settings in accordance with some embodiments of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used and structural changes are optionally made without departing from the scope of the disclosed embodiments.

There is a need for presenting subtitles for content items according to language settings of respective users. In some circumstances, an electronic device displays subtitles for a content item, and in other circumstances forgoes display of subtitles for a content item according to language settings, including preferred languages and a region of a user. Adjusting subtitles for various portions of a content item according to language settings of respective users ensures that subtitles are appropriately displayed or not displayed without the need for further input to manually control the subtitles, thus improving user experience while consuming content. Further, such techniques can reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

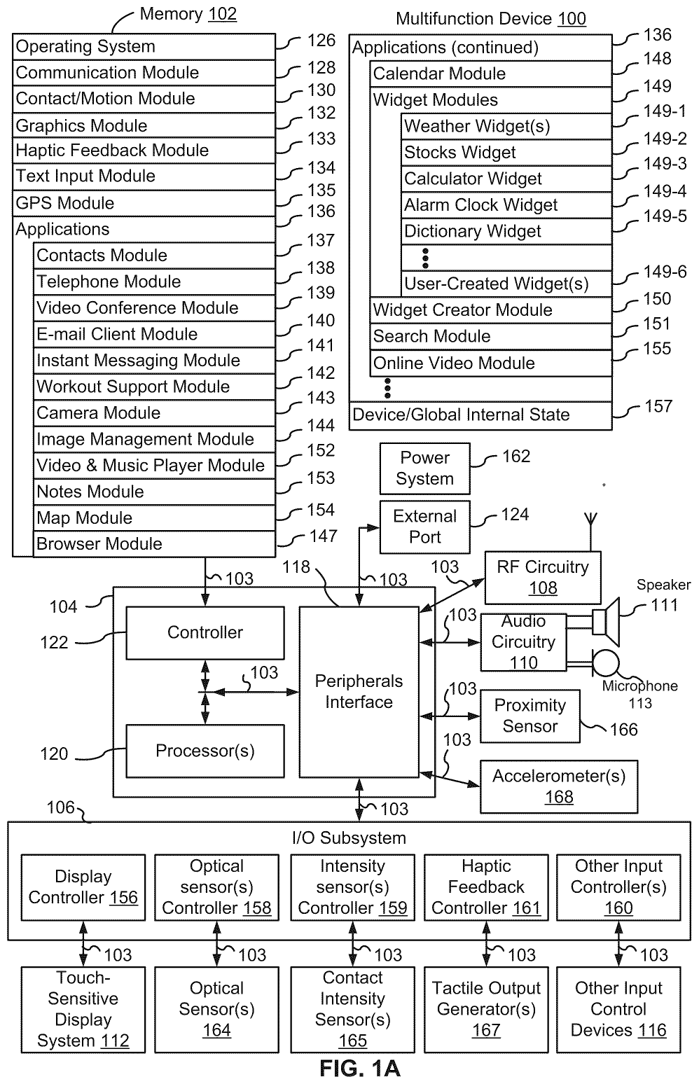

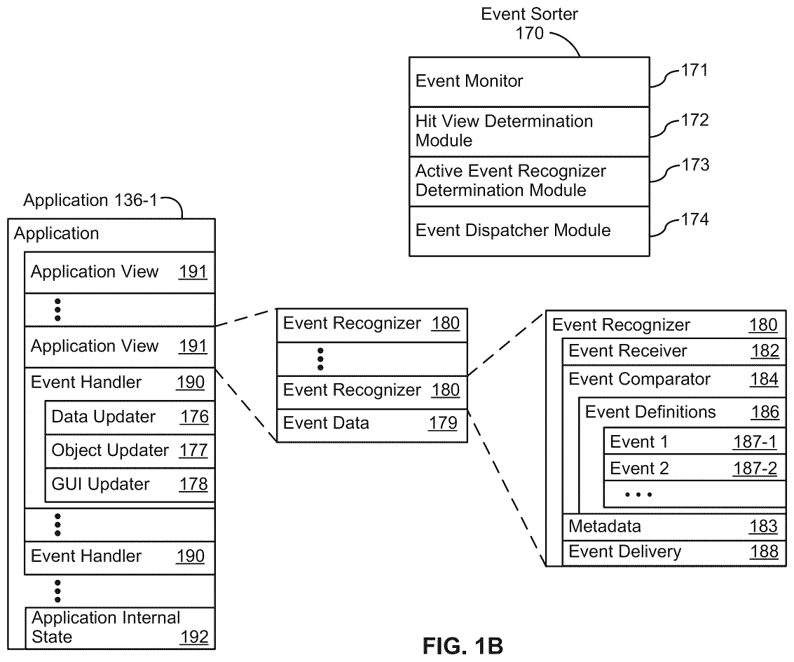

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

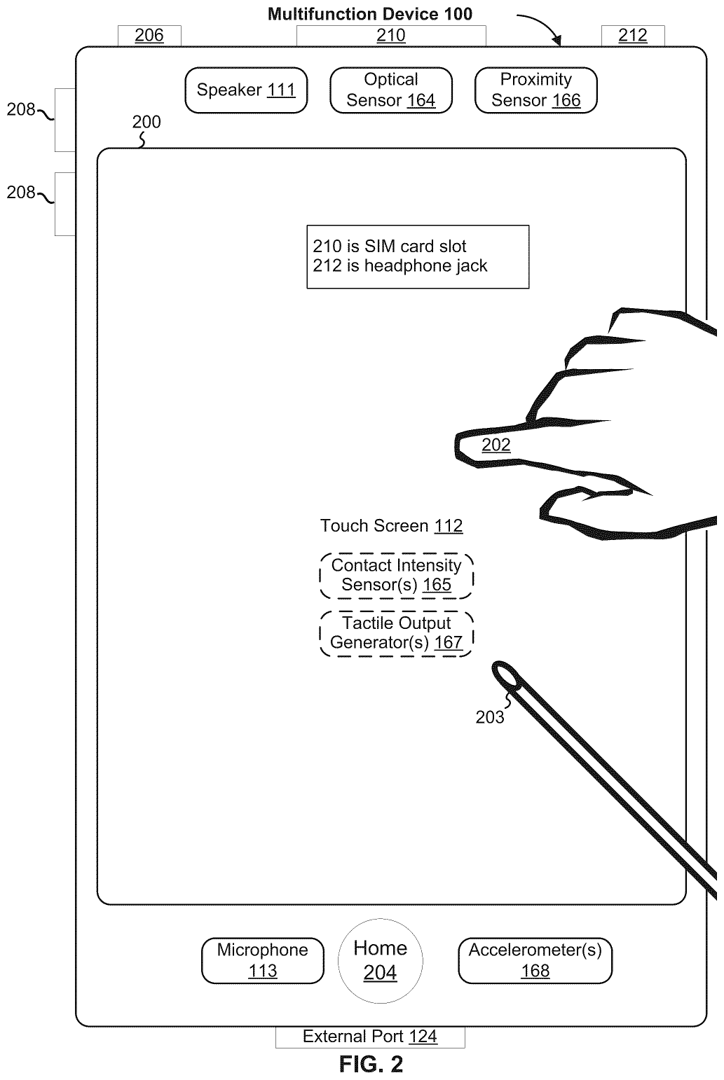

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

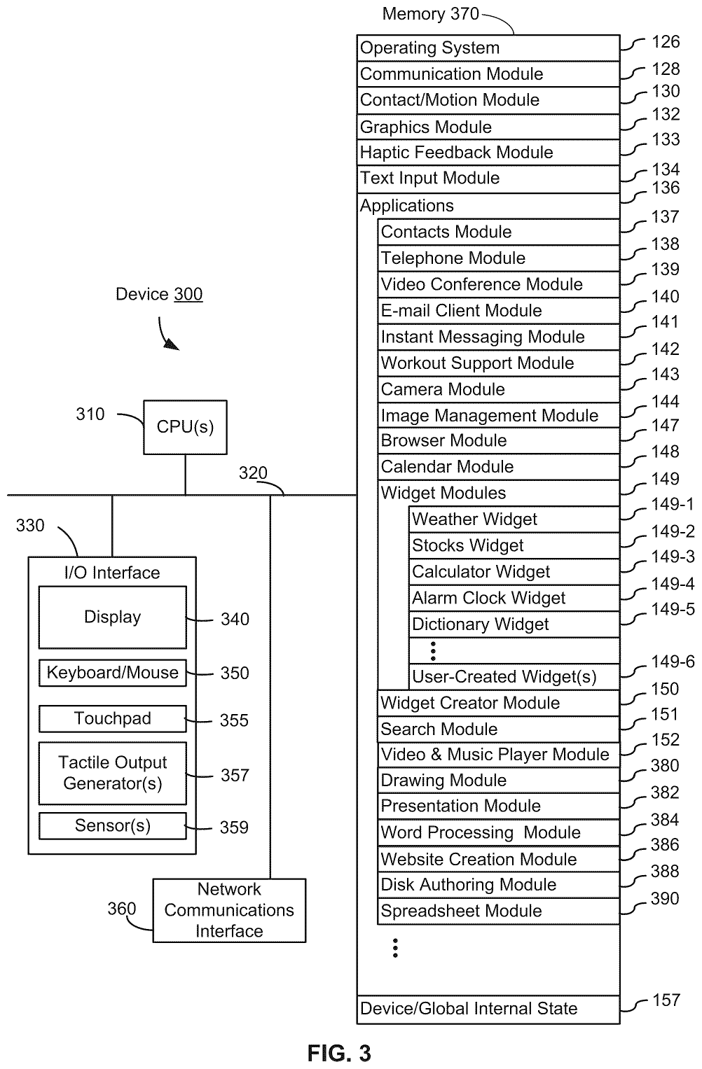

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

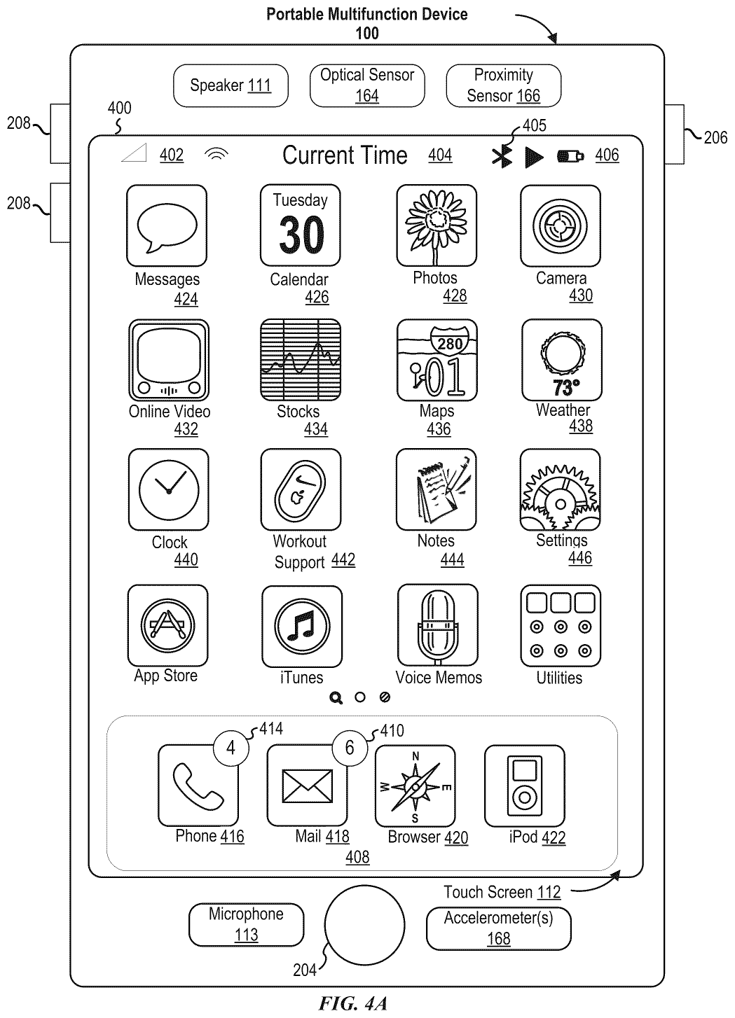

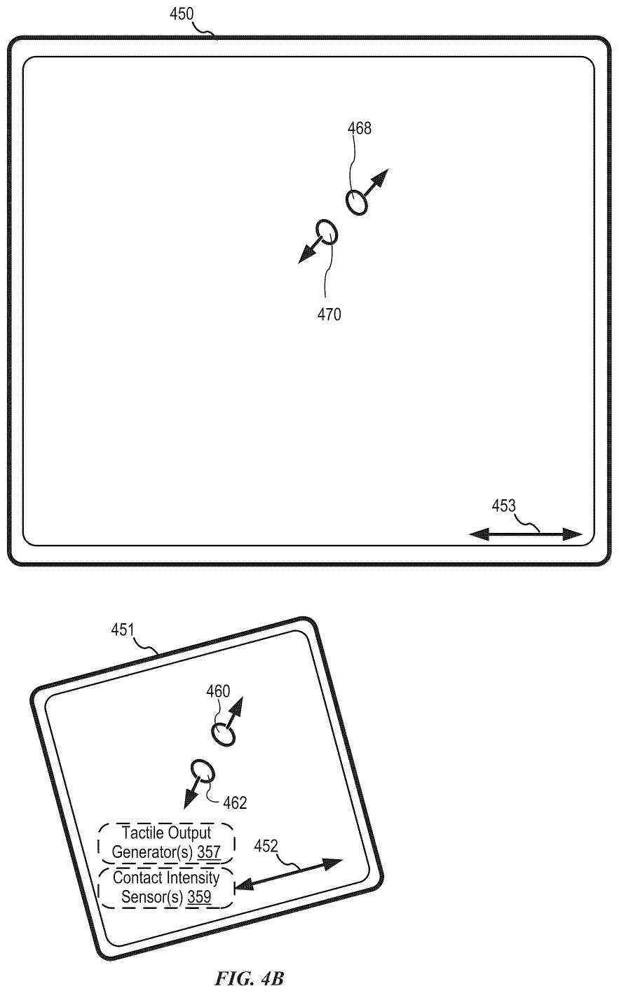

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

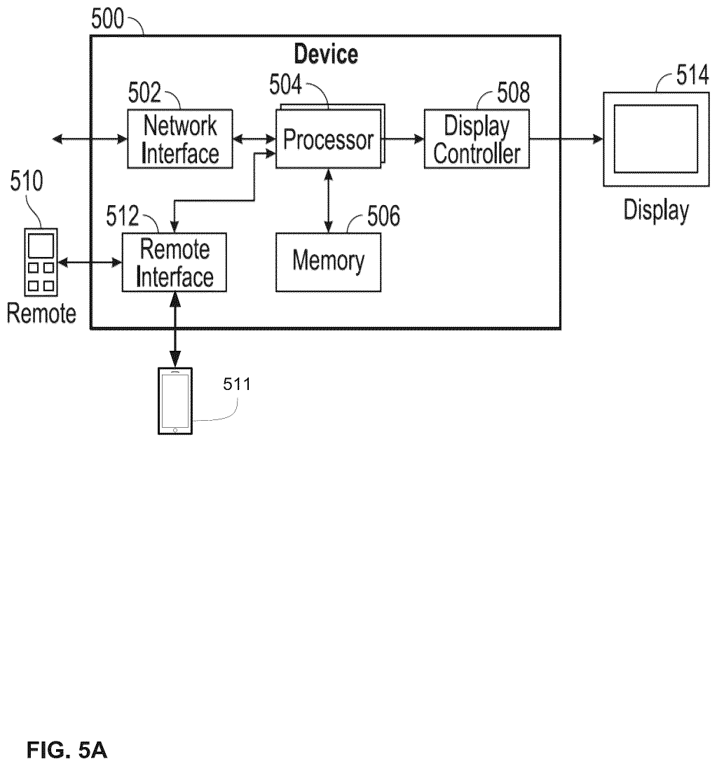

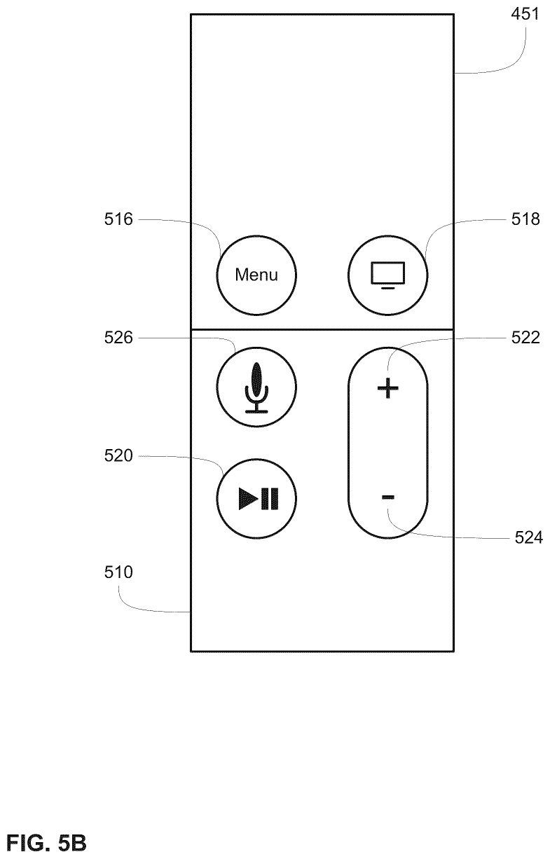

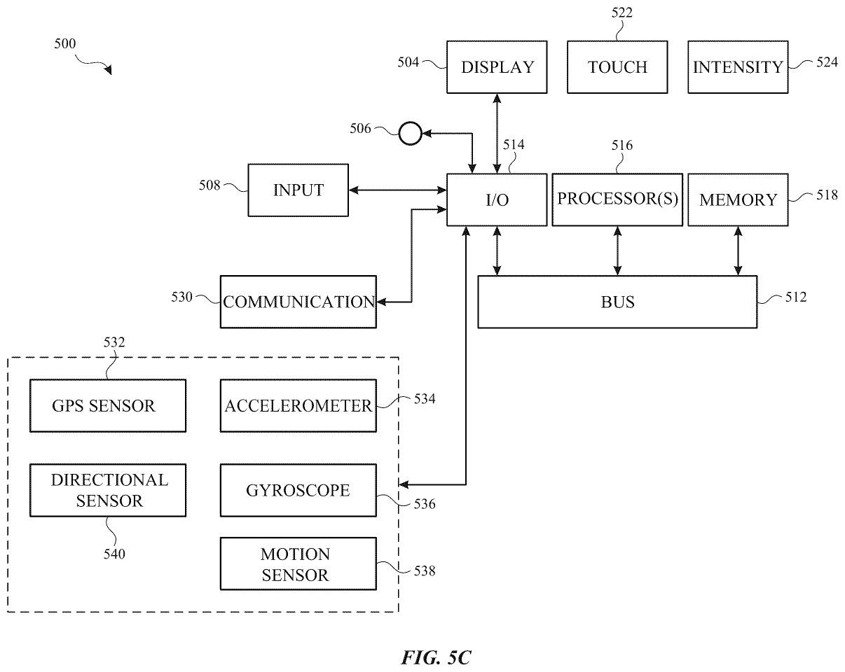

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 504 optionally execute any number of programs stored in memory 506 or storage, which optionally includes instructions to perform one or more of the methods and/or processes described herein (e.g., method 700). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, display controller 508 causes the various user interfaces of the disclosure to be displayed on display 514. Further, input to device 500 is optionally provided by remote 510 via remote interface 512, which is optionally a wireless or a wired connection. In some embodiments, input to device 500 is provided by a multifunction device 511 (e.g., a smartphone) on which a remote control application is running that configures the multifunction device to simulate remote control functionality, as will be described in more detail below. In some embodiments, multifunction device 511 corresponds to one or more of device 100 in FIGS. 1A and 2, and device 300 in FIG. 3. It is understood that the embodiment of FIG. 5A is not meant to limit the features of the device of the disclosure, and that other components to facilitate other features described in the disclosure are optionally included in the architecture of FIG. 5A as well. In some embodiments, device 500 optionally corresponds to one or more of multifunction device 100 in FIGS. 1A and 2 and device 300 in FIG. 3; network interface 502 optionally corresponds to one or more of RF circuitry 108, external port 124, and peripherals interface 118 in FIGS. 1A and 2, and network communications interface 360 in FIG. 3; processor 504 optionally corresponds to one or more of processor(s) 120 in FIG. 1A and CPU(s) 310 in FIG. 3; display controller 508 optionally corresponds to one or more of display controller 156 in FIG. 1A and I/O interface 330 in FIG. 3; memory 506 optionally corresponds to one or more of memory 102 in FIG. 1A and memory 370 in FIG. 3; remote interface 512 optionally corresponds to one or more of peripherals interface 118, and I/O subsystem 106 (and/or its components) in FIG. 1A, and I/O interface 330 in FIG. 3; remote 512 optionally corresponds to and or includes one or more of speaker 111, touch-sensitive display system 112, microphone 113, optical sensor(s) 164, contact intensity sensor(s) 165, tactile output generator(s) 167, other input control devices 116, accelerometer(s) 168, proximity sensor 166, and I/O subsystem 106 in FIG. 1A, and keyboard/mouse 350, touchpad 355, tactile output generator(s) 357, and contact intensity sensor(s) 359 in FIG. 3, and touch-sensitive surface 451 in FIG. 4B; and, display 514 optionally corresponds to one or more of touch-sensitive display system 112 in FIGS. 1A and 2, and display 340 in FIG. 3.

FIG. 5B illustrates an exemplary structure for remote 510 according to some embodiments of the disclosure. In some embodiments, remote 510 optionally corresponds to one or more of multifunction device 100 in FIGS. 1A and 2 and device 300 in FIG. 3. Remote 510 optionally includes touch-sensitive surface 451. In some embodiments, touch-sensitive surface 451 is edge-to-edge (e.g., it extends to the edges of remote 510, such that little or no surface of remote 510 exists between the touch-sensitive surface 451 and one or more edges of remote 510, as illustrated in FIG. 5B). Touch-sensitive surface 451 is optionally able to sense contacts as well as contact intensities (e.g., clicks of touch-sensitive surface 451), as previously described in this disclosure. Further, touch-sensitive surface 451 optionally includes a mechanical actuator for providing physical button click functionality (e.g., touch-sensitive surface 451 is “clickable” to provide corresponding input to device 500). Remote 510 also optionally includes buttons 516, 518, 520, 522, 524 and 526. Buttons 516, 518, 520, 522, 524 and 526 are optionally mechanical buttons or mechanical button alternatives that are able to sense contact with, or depression of, such buttons to initiate corresponding action(s) on, for example, device 500. In some embodiments, selection of “menu” button 516 by a user navigates device 500 backwards in a currently-executing application or currently-displayed user interface (e.g., back to a user interface that was displayed previous to the currently-displayed user interface), or navigates device 500 to a one-higher-level user interface than the currently-displayed user interface. In some embodiments, selection of “home” button 518 by a user navigates device 500 to a main, home, or root user interface from any user interface that is displayed on device 500 (e.g., to a home screen of device 500 that optionally includes one or more applications accessible on device 500). In some embodiments, selection of the “home” button 518 causes the electronic device to navigate to a unified media browsing application. In some embodiments, selection of “play/pause” button 520 by a user toggles between playing and pausing a currently-playing content item on device 500 (e.g., if a content item is playing on device 500 when “play/pause” button 520 is selected, the content item is optionally paused, and if a content item is paused on device 500 when “play/pause” button 520 is selected, the content item is optionally played). In some embodiments, selection of “+” 522 or “−” 524 buttons by a user increases or decreases, respectively, the volume of audio reproduced by device 500 (e.g., the volume of a content item currently-playing on device 500). In some embodiments, selection of “audio input” button 526 by a user allows the user to provide audio input (e.g., voice input) to device 500, optionally, to a voice assistant on the device. In some embodiments, remote 510 includes a microphone via which the user provides audio input to device 500 upon selection of “audio input” button 526. In some embodiments, remote 510 includes one or more accelerometers for detecting information about the motion of the remote.

FIG. 5C depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

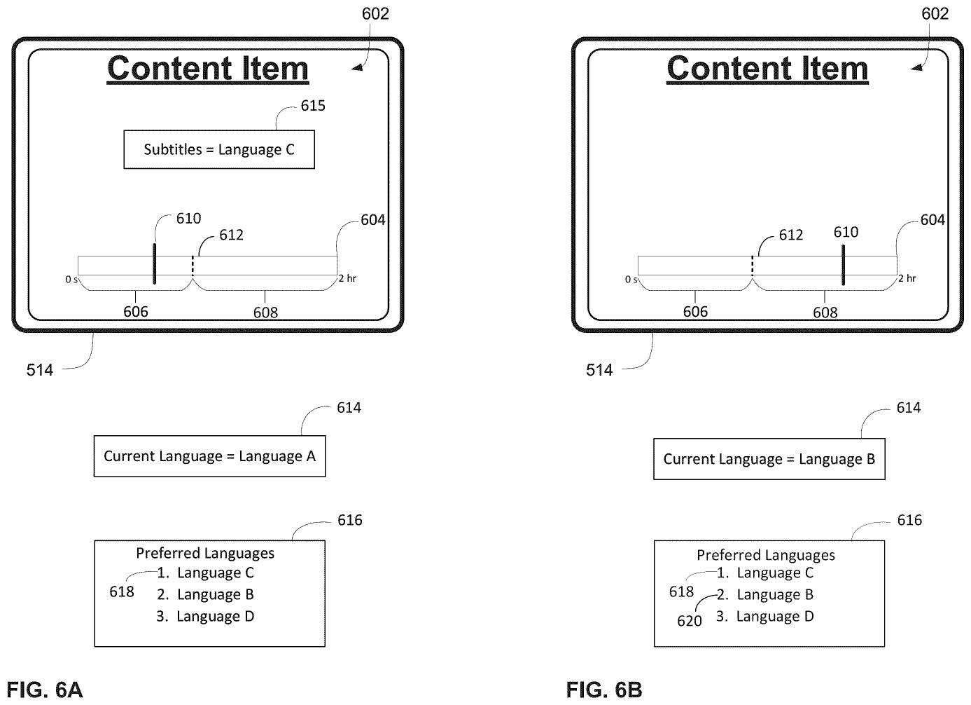

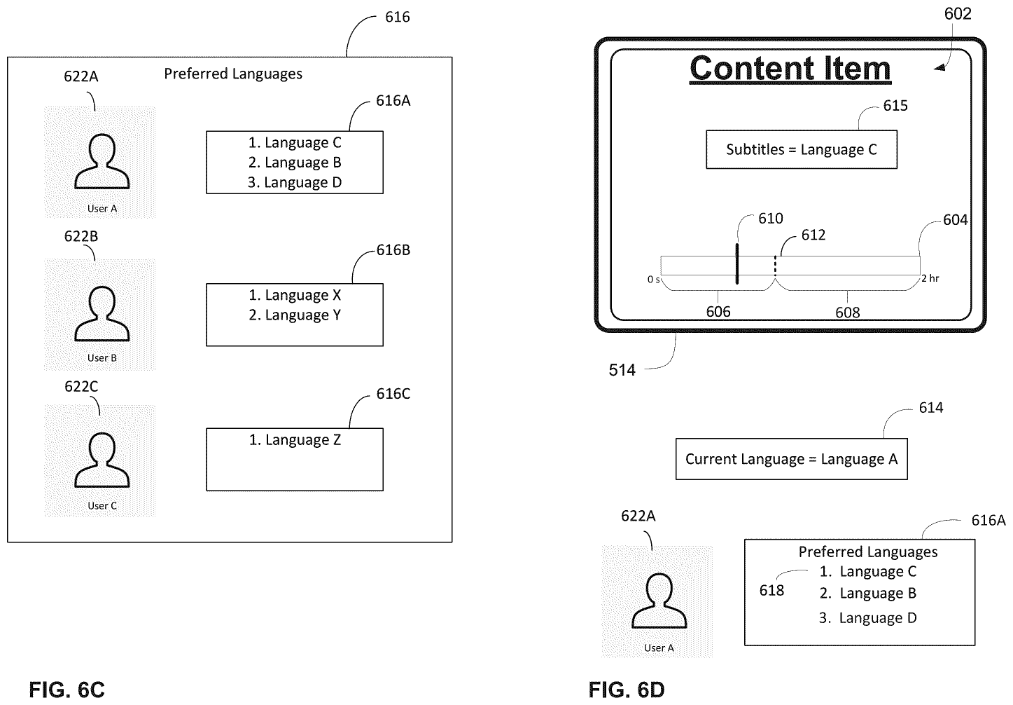

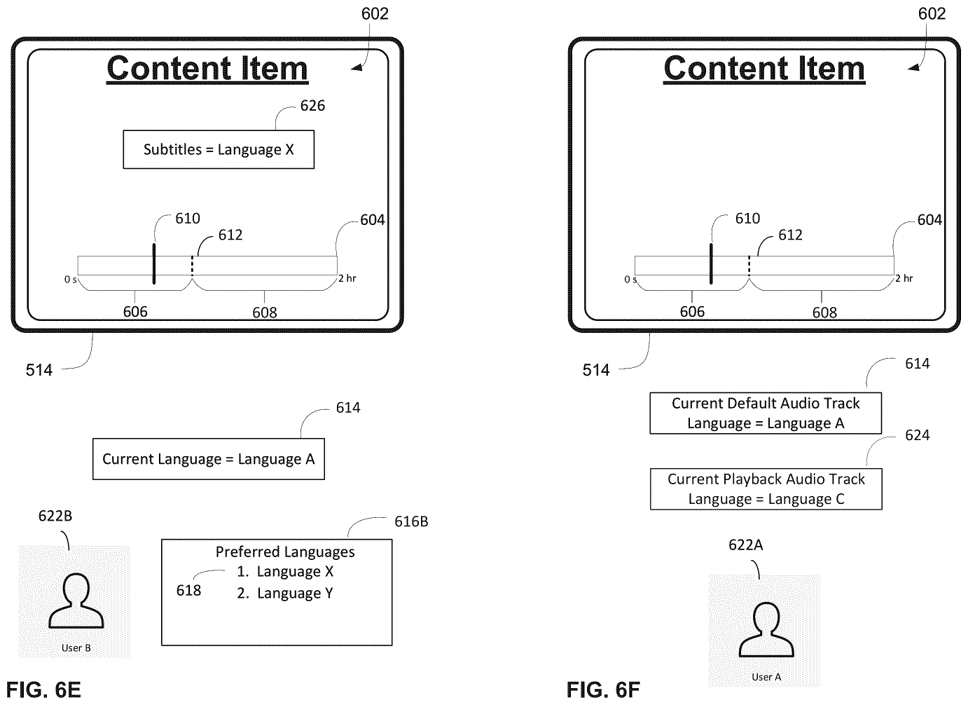

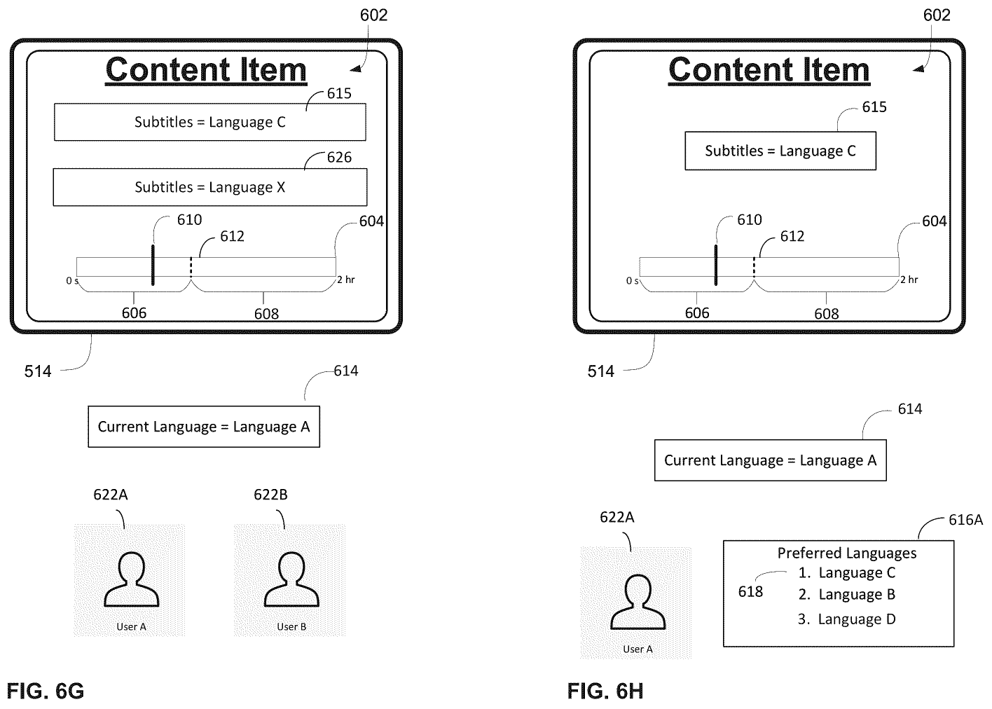

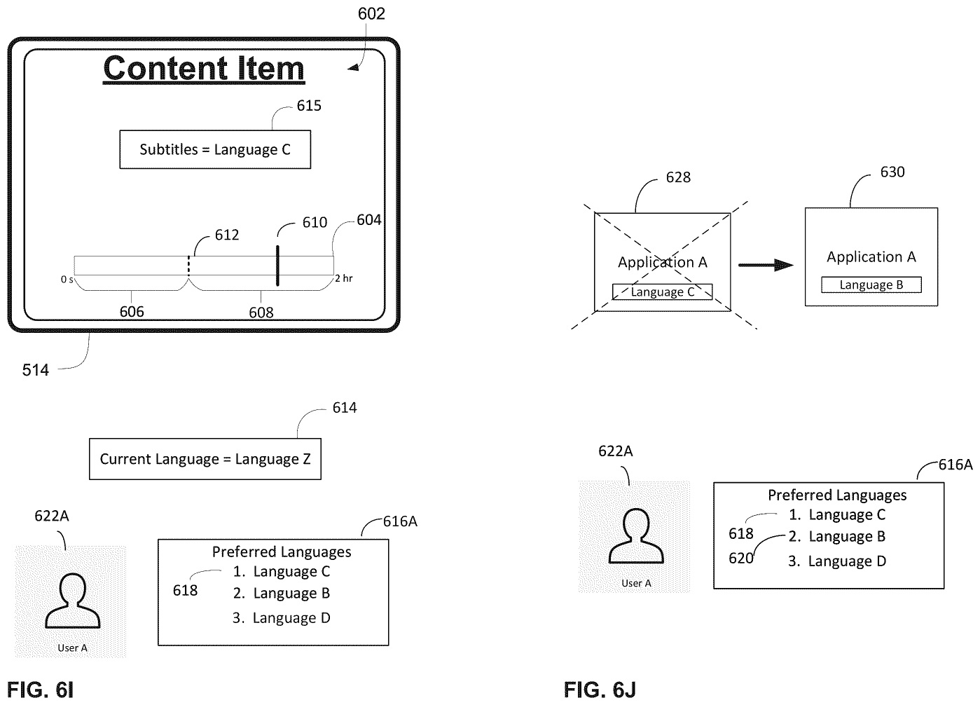

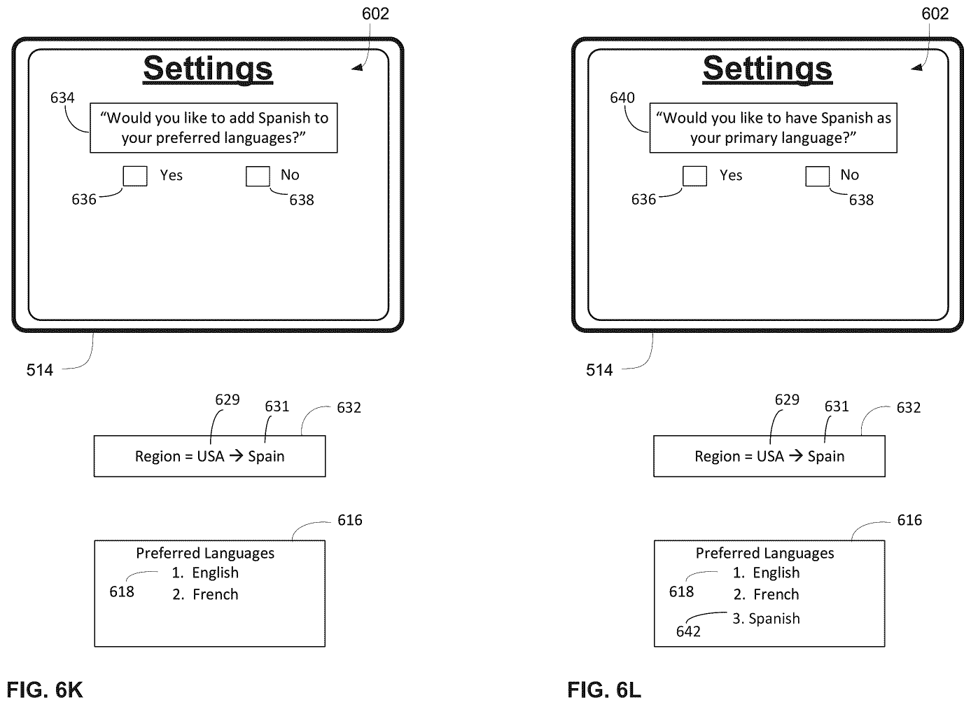

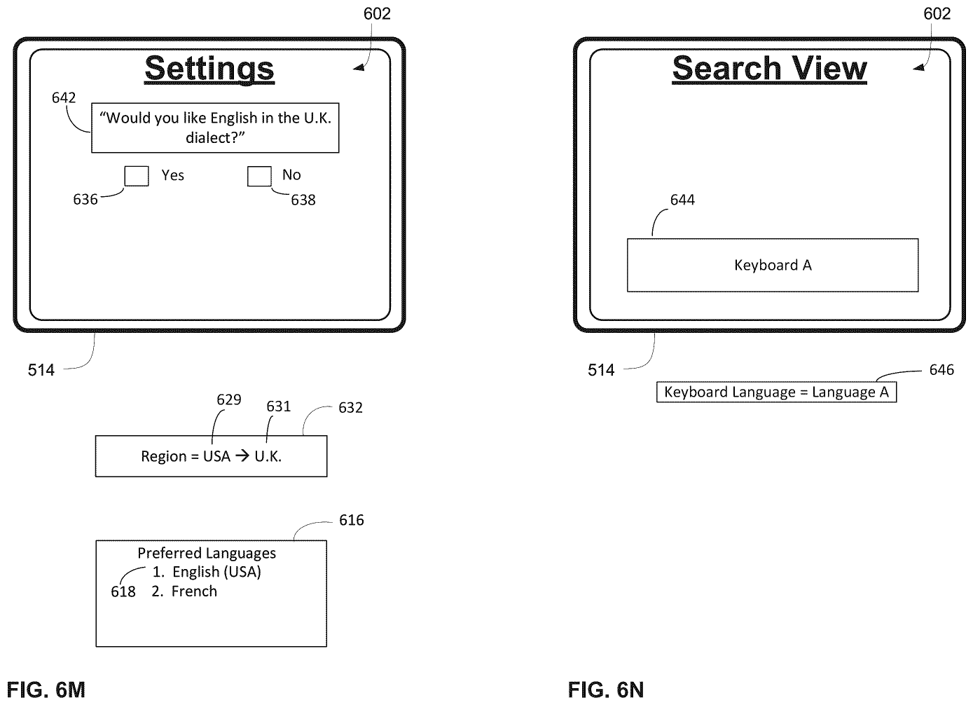

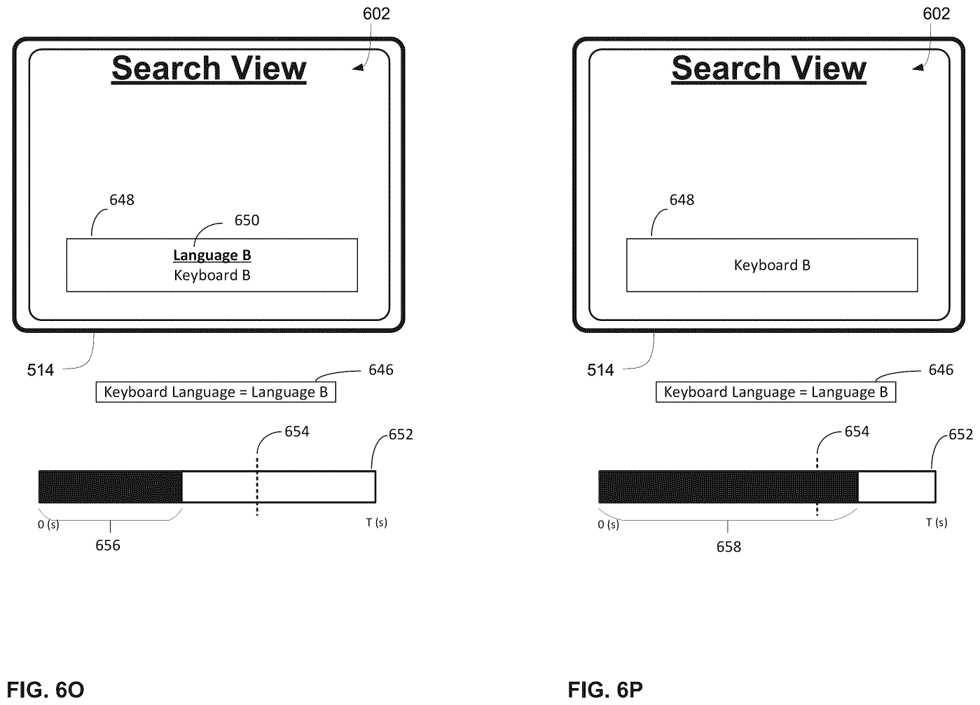

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes described with reference to FIGS. 6-11. A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. but can include other or additional components in multiple configurations.

In some embodiments, electronic device 500 includes one or more tactile output generators, where the one or more tactile output generators generate different types of tactile output sequences, as described below in Table 1. In some embodiments, a particular type of tactile output sequence generated by the one or more tactile output generators of the device corresponds to a particular tactile output pattern. For example, a tactile output pattern specifies characteristics of a tactile output, such as the amplitude of the tactile output, the shape of a movement waveform of the tactile output, the frequency of the tactile output, and/or the duration of the tactile output. When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

One or more of the embodiments disclosed herein optionally include one or more of the features disclosed in the following patent applications: “User Interfaces For Interacting with Channels that Provide Content that Plays in a Media Browsing Application” (Attorney Docket No.: 106843171600 (P42089USP1), filed Mar. 24, 2019), “User Interfaces For a Media Browsing Application” (Attorney Docket No.: 106843171700 (P42090USP1), filed Mar. 24, 2019), and “User Interface Specific to Respective Content Items” (Attorney Docket No.: 106843171900 (P42092USP1), filed Mar. 24, 2019), each of which is hereby incorporated by reference.

Attention is now directed towards embodiments of user interfaces (“UP”) and associated processes that are implemented on an electronic device, such as portable multifunction device 100, device 300, or device 500.

### User Interfaces and Associated Processes

### Subtitles for Content Items

Users wish to consume content items, via users interfaces, that include many types of content, including media content. In some circumstances, an electronic device displays subtitles for a content item, and in other circumstances forgoes display of subtitles for a content item according to language settings, including preferred languages and a region of a user. Adjusting subtitles for various portions of a content item according to language settings of respective users ensures that subtitles are appropriately displayed or not displayed without the need for further input to manually control whether the subtitles are displayed or not displayed, thus reducing the amount of time a user needs to perform operations with the electronic device, and reducing the power usage of the electronic device, which increases battery life for battery-powered devices. It is understood that people use devices. When a person uses a device, that person is optionally referred to as a user of the device.

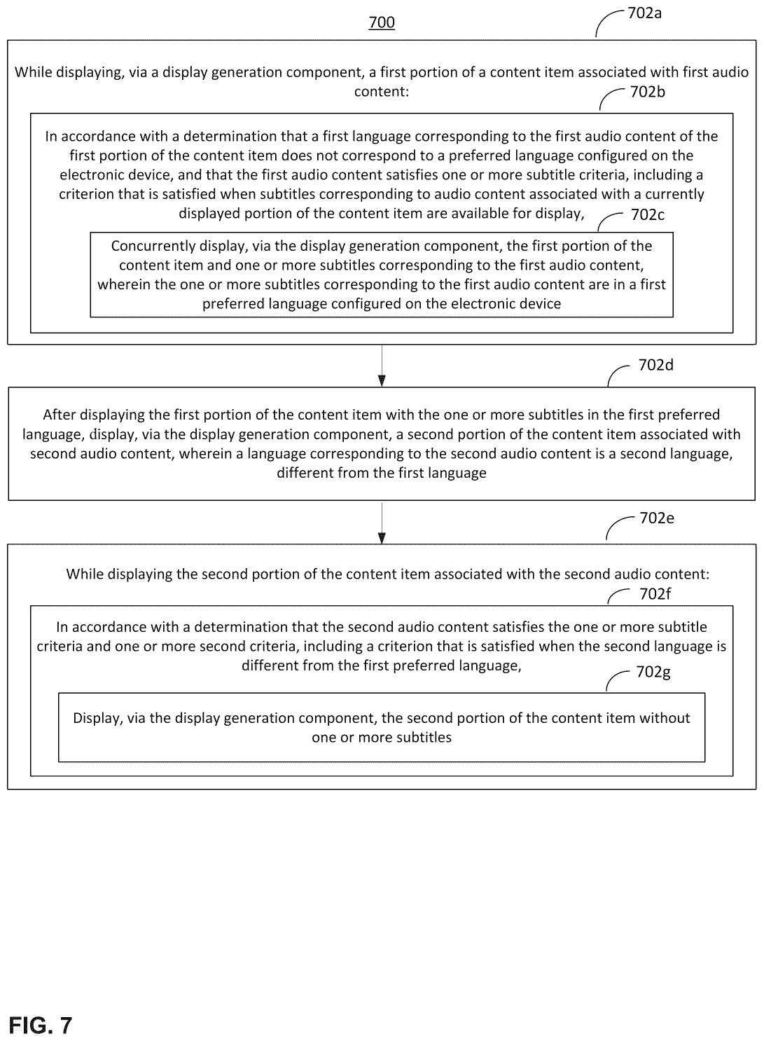

FIGS. 6A-6P illustrate exemplary ways in which an electronic device presents subtitles for content items based on language settings in accordance with some embodiments of the disclosure. The embodiments in these figures are used to illustrate the processes described below, including the processes described with reference to FIG. 7.

FIG. 6A illustrates a media playback user interface 602 displayed by an electronic device (e.g., device 500) via display device 514. In FIG. 6A, user interface 602 includes a content item that is playing, and a scrubber bar 604 corresponding to the playing content item. The content item optionally is in a video format such as a movie, a television show, a music video, or an advertisement, or in an audio format such as a song or a podcast. The scrubber bar 604 includes a playback position indicator 610 that indicates the current playback position and/or current time of playback with respect to the length of the content of item (e.g., amount of time that has elapsed since playback of the content item has begun). In some embodiments, the scrubber bar has different sizes for different lengths of the content item (e.g., 30 s, 30 min, 1, 2, 3, or 5 hr). The content item is optionally segmented into any number of portions with varying lengths, such as portion 606 and portion 608, based on varying time intervals and/or number frames. As illustrated, the length of the content item is 2 hours. Portion 606 has a duration of approximately 45 minutes (e.g., from 0 s to 45 min), and portion 608 has a duration of approximately 75 minutes (e.g., from 45 min to 2 hr). Further, the playback position indicator 610 is located in portion 606 of the content item. In some embodiments, one or more portion indicators help distinguish between different portions of the content item. For example, portion indicator 612 separates portion 606 from portion 608. In some embodiments, the portion indicator 612 is not displayed in the media playback user interface 602. In some embodiments, the portion indicator 612 is displayed in the media playback user interface 602. In some embodiments, portion 606 includes audio content in the same language as audio content of portion 608. In some embodiments, portion 606 includes audio content in a different language than audio content of portion 608. For example, the current language 614 of portion 606 is language A (e.g., audio content of portion 606 is language A).

In response to the playback position indicator 610 being in portion 606 and current language 614 of portion 606 being language A, which is not a preferred language configured on device 500 (e.g., as indicated in 616), the electronic device optionally displays subtitles 615 in language C, which is a preferred language of a user (e.g., as indicated in 616). In fact, language C is a first preferred language (e.g., primary language) 618 of the user. Thus, during playback of portion 606, the electronic device optionally displays subtitles 615 in the first preferred language 618 of the user. In some embodiments, the electronic device has access to subtitle data for the audio content of portion 606 of the content item, optionally including subtitle data for displaying subtitles in one or more of all of the preferred languages set in the electronic device. In some embodiments, the electronic device optionally defaults to operating according to the first preferred language (e.g., primary language) 618 if the relevant function (e.g., subtitles or application localization, as described later) is available in the first preferred language 618. However, if the relevant function is not available in the first preferred language 618, then the electronic device instead optionally operates according to a secondary preferred language (e.g., a second preferred language or a third preferred language) for the relevant function.

In some embodiments, the electronic device (e.g., device 500) displays a menu of preferred languages via the display device 514. The electronic device is optionally configured to operate according to a user selection of any number of preferred languages 616 (e.g., 1, 2, 3, 4, 5, or 10 preferred languages). In some embodiments, the electronic device is configured with a single primary language, and the remaining one or more preferred languages that are configured on the electronic device are secondary languages. As illustrated, the preferred languages 616 of the user include language C as the first preferred language 618, language B as the second preferred language, and language D as the third preferred language.

From FIG. 6A to FIG. 6B, the electronic device continues playback of the content item such that the current playback position (e.g., indicated by playback position indicator 610) in the content item crosses over from portion 606 to portion 608 of the content item. In FIG. 6B, portion 606 includes audio content in a different language than audio content of portion 608. That is, the current language 614 of portion 606 is language A (e.g., audio content of portion 606 is language A), and the current language 614 of portion 608 is language C (e.g., audio content of portion 608 is language C). In response to the current language 614 (e.g., language B) of portion 608 being different from the first preferred language 618 but corresponding to a preferred language 616 of the user, the electronic device foregoes displaying subtitles during playback of portion 608. In fact, the current language 614 (e.g., language B) of portion 608 is the second preferred language 620 of the user. In some embodiments, the user is more proficient in the first preferred language compared to secondary preferred languages (e.g., second preferred language or third preferred language). In some embodiments, the user is equally proficient in the first preferred language as the secondary preferred languages (e.g., second preferred language or third preferred language).

FIG. 6C illustrates preferred languages 616 corresponding to respective users, such as user 622A, user 622B, and user 622C. In some embodiments, the electronic device prompts each user to select one or more preferred languages 616. For each user, the preferred languages 616 optionally include one or more of a first preferred language (e.g., primary language), a second preferred language (e.g., a first secondary language), a third preferred language (e.g., a second secondary language), and so forth. As illustrated in FIG. 6C, the electronic device separately stores any number of preferred language settings 616A, 616B, and 616C for respective users 622A, 622B, and 622C. As mentioned above, in some embodiments, the electronic device displays a menu of preferred languages to prompt a user to select one or more preferred languages 616. For example, the electronic device optionally stores preferred language settings 616A, which include language C as a first preferred language, language, language B as a second preferred language, and language D as a third preferred language, for user 622A. The electronic device optionally stores preferred language settings 616B, which include language X as a first preferred language and language Y as a second preferred language, for user 622B. Further, the electronic device optionally stores preferred language settings 616C, which include language Z as a first preferred language, for user 622C.

FIG. 6D illustrates the media playback user interface 602 displayed by the electronic device (e.g., device 500) via the display device 514 according to preferred language settings 616 of a currently active user, such as user 622A. In some embodiments, the electronic device determine that a certain user is currently active based on receiving login information of the user, facial recognition information of the user, or a selection of a profile of the user. In some embodiments, the electronic device (e.g., smart television or set-top box) discovers an input device associated with the user (e.g., another mobile device separate from the electronic device, such as a smartphone, that is logged into and/or configured with the same user account or profile as the electronic device) via a communication protocol (e.g., Bluetooth, Wi-Fi, or other wireless communication protocol). The presence of the input device (e.g., smartphone) corresponding to the user optionally indicates that the user has an active status (e.g., consuming the content displayed by the smart television). In some embodiments, the electronic device optionally determines that the user is currently active and consuming the content based on facial recognition of the user via the input device (e.g., smartphone or one or more cameras in communication with the electronic device). As illustrated in FIG. 6D, user 622A is currently active, and the electronic device is configured to operate according to the preferred language settings 616A of the user 622A. Further, the playback position indicator 610 is in portion 606 of the content item corresponding to audio data in language A. Because the current language 614 (e.g., language A) of portion 606 is not a preferred language of the user 622A, the electronic device optionally displays subtitles 615 in a preferred language of the user 622A, such as a first preferred language (e.g., primary language) 618. Accordingly, the media playback user interface 602 includes subtitles 615 in language C, which is the first preferred language 618 of the user 622A, during playback of portion 606.

From FIG. 6D to FIG. 6E, the electronic device determines that user 622B is currently active rather than user 622A. In response to the user 622B being currently active, the electronic device is configured to operate according to the preferred language settings 616B of the user 622B. Like FIG. 6D, the playback position indicator 610 in FIG. 6E is also in portion 606 corresponding to audio data in language A. However, because the current language 614 (e.g., language A) of portion 606 is not a preferred language of user 622B, the electronic device displays subtitles 626 in a preferred language of user 622B, such as a first preferred language (e.g., primary language) 618. The media playback user interface 602 includes subtitles 626 in language X, which is the first preferred language 618 of the user 622B, during playback of portion 606.

In FIG. 6F, the electronic device adjusts an audio track of the content item according to the preferred language settings of user 622A. As illustrated, the playback position indicator 610 is in portion 606 of the content item corresponding to audio content in language A. Because the current default audio track language 614 of portion 606 content item is language A rather than a preferred language of user 622A, the electronic device adjusts the audio track of portion 606 such that the current playback audio track language 624 is a preferred langue of user 622A, such as a first preferred language (e.g., language C). In some embodiments, the electronic device forgoes displaying subtitles when adjusting the language of the audio track of the content item based on preferred language settings of a user. In some embodiments, the electronic device automatically (e.g., without user input) changes the audio track of portion 606 to an audio track in the first-available preferred language of the user 622A. In some embodiments, in response to receiving a confirmation input from the user 622A (e.g., upon initiating playback of portion 606 or upon the current playback position in the content item reaching portion 606 of the content item), the electronic device changes the audio track of portion 606 to an audio track in the first-available preferred language of the user 622A.

FIG. 6G illustrates the media playback user interface 602 including subtitles (e.g., first set of subtitles) 615 and other subtitles (e.g., second set of subtitles) 626 according to preferred language settings of user 622A and user 622B. In some embodiments, multiple users (e.g., 2, 3, 4, or 5 users) are currently active and watching playback of the content item at one time. In some embodiments, the electronic device (e.g., smart television) determines that the multiple users are currently active at one time based on discovering respective input devices (e.g., smartphones) of the multiple users via respective communication protocols (e.g., Bluetooth, Wi-Fi, or other wireless communication protocol) and/or via facial recognition of the multiple users.

As illustrated, user 622A and user 622B are currently active and consuming the content item simultaneously. Further, the playback position indicator 610 is in portion 606 of the content item corresponding to audio content in language A. However, language A is not a preferred language for user 622A nor user 622B. Based on language A not being a preferred language, the electronic device displays the first set of subtitles 615 according to the preferred language settings of user 622A and the second set of subtitles 626 according to the preferred language settings of user 626B. The first set of subtitles 615 are in language C, the first preferred language (e.g., primary language) of user 622A. The second set of subtitles 626 are in language X, the first preferred language (e.g., primary language) of user 622B. In some embodiments, the first set of subtitles 615 and the second set of subtitles 626 are optionally in a secondary preferred language, such as a second preferred language or a third preferred language, if the electronic device does not have access to subtitle date in the first preferred language for portion 606. For example, in accordance with a determination that subtitles are not available in language C (e.g., the first preferred language of user 622A), the electronic device optionally displays the first set of subtitles 615 in language B, the second preferred language of user 622A.

FIG. 6H illustrates a media playback user interface 602 according to preferred language settings of user 622A. Similar to FIG. 6A, the playback position indicator 610 is located in portion 606 of the content item corresponding to audio content in language A. However, language A is not a preferred language for user 622A. In response to language A not being a preferred language of user 622A, the electronic device optionally displays the subtitles 615 according to the preferred language settings 616A of user 622A. As such, the subtitles 615 are in language C, the first preferred language (e.g., primary language) 618 of user 622A.

From FIG. 6H to FIG. 6I, the electronic device continues playback of the content item for user 622A such that the current playback position (e.g., indicated by playback position indicator 610) in the content item crosses over from portion 606 to portion 608 of the content item. In FIG. 6I, portion 606 includes audio content in a different language than audio content of portion 608. That is, current language 614 of portion 606 is language A (e.g., audio content of portion 606 is language A) while the current language 614 of portion 608 is language Z (e.g., audio content of portion 608 is language Z). Like language Z, language A is not a preferred language 616A for user 622A. In response to the playback position indicator 610 being in portion 608 and the current language 614 of portion 608 being language Z, which is not a preferred language 616A of user 622A, the electronic device optionally continues displaying subtitles 615 in language C, the first preferred language (e.g., primary language) 618 of the user 622A.

According to FIG. 6J, the electronic device displays a user interface of an application according to preferred language settings 616A of user 622A. In some embodiments, the electronic device displays the user interface of the application in response to receiving user input (e.g., selection of an application icon on a home screen user interface of the electronic device). In response to localization 628 of the application in the first preferred language 618 (e.g., language C) of the user 622A being unavailable, the electronic device optionally displays the user interface of the application in a secondary preferred language of the user 622A. For example, as illustrated, the electronic device updates localization settings to localization 630 such that the user interface of the application is in language B, the second preferred language 620 of user 622A. As used herein, localization of the application in a particular language optionally refers to text, layout, graphics, multimedia, keyboard shortcuts, fonts, character sets, access to remote data or content (e.g., access to streaming content), and/or local data of the application is available for display in the particular language of a user. In some embodiments, in response to a localization of the application in the first preferred language 618 (e.g., language C) of the user 622A being available, the electronic device optionally displays the user interface of the application in default localization settings, in the first preferred language 618.

FIGS. 6K to 6M illustrate respective settings views in the media playback user interface 602 in response to a change in region of a user. In FIG. 6K, the electronic device displays prompt 634 in the settings view in response to the region 632 of the user changing from the U.S. (e.g., first region 629) to Spain (e.g., second region 631). In some embodiments, the electronic device optionally receives user input directed to changing the region 632. In some embodiments, the region 632 includes a country, a state within a country, a continent, a city, or a group of cities, and so forth. In response to such user input, the electronic device optionally updates the region 632 (as displayed by the settings view) from the first region 629 (e.g., U.S.) to the second region 631 (e.g., Spain). In some embodiments, each region is optionally associated with a predefined set of one or more languages. For example, English is predominantly spoken by people or residents of the U.S. while Spanish is predominantly spoken by people or residents of Spain.

As illustrated, the preferred languages 616 of the user include English as the first preferred language 618 and French as the second preferred language. In accordance with a determination that the user is in Spain and Spanish is not a preferred language of the user, the electronic device optionally prompts the user to designate Spanish as a preferred language. For example, the prompt 634 includes a message, such as “Would you like to add Spanish to your preferred languages?” In addition to displaying the message, the electronic device optionally displays a “yes” affordance 636 and a “no” affordance 638 in the settings view. In response to receiving a selection of the “yes” affordance 636, the electronic device optionally adds the Spanish to the preferred languages 616 of the user (e.g., as a primary language or as a secondary language). In response to receiving a selection of the “no” affordance 638, the electronic device optionally forgoes adding Spanish to the preferred languages 616 of the user.

In some embodiments, the electronic device presents a prompt to update display frequency of the content item and/or of display 514 and/or of device 500 according to the change in region 632. For example, the prompt optionally includes displaying a message such as “Would you like to change the display frequency to 50 Hz?” in accordance with the region 632 changing to Spain (e.g., where the prior region was the U.S., which optionally operates according to a 60 Hz display frequency). In response to receiving a selection of the “yes” affordance, the electronic device optionally changes the display frequency from 60 Hz. to 50 Hz. In response to receiving a selection of the “no” affordance, the electronic device optionally forgoes changing the display frequency.

In some embodiments, if the electronic device does not receive input designating or configuring one or more preferred languages at the electronic device, as default, the electronic device optionally sets the first preferred language to a language associated with a region in which the electronic device is located (e.g., if the electronic device is located in North America, the electronic device sets the first preferred language to be English). In some embodiments, before setting the first preferred language to a language associated with a region in which the electronic device is located, the electronic device optionally displays a verification request to the user.

In some embodiments, when changing from the first region 629 to the second region 631, the language associated with the second region is a preferred language, different from the first preferred language, of the user. Unlike FIG. 6K, where the language associated with the second region is not a preferred language, FIG. 6L illustrates a settings views in the media playback user interface 602 given the change in region 632 and that the language associated with the second region 631 is a preferred language. From FIG. 6K to FIG. 6L, the preferred languages 616 of the user have been adjusted such that the preferred languages 616 include Spanish as a third preferred language 642. Like FIG. 6K, the preferred languages 616 in FIG. 6L also include English as the first preferred language 618 and French as the second preferred language. In FIG. 6K, the electronic device displays prompt 640 in the settings view in response to the region 632 of the user changing from the U.S. to Spain. In accordance with a determination that the user is in Spain and Spanish is a secondary preferred language (e.g., the third preferred language 642) of the user, the electronic device optionally prompts the user to designate Spanish as the first preferred language 618. For example, the prompt 640 includes a message, such as “Would you like to have Spanish as your primary language?” In response to receiving a selection of the “yes” affordance 636, the electronic device optionally changes the first preferred language 618 from English to Spanish. In some embodiments, in response to receiving the selection of the “yes” affordance 636, the electronic device also optionally changes the second preferred language from French to English and the third preferred language 642 from Spanish to French. In response to receiving a selection of the “no” affordance 638, the electronic device optionally forgoes changing the first preferred language 618 to Spanish. Instead, the first preferred language 618 optionally remains as it was prior to the electronic device detecting the change in the region 632.

FIG. 6M illustrates a settings views in the media playback user interface 602 given the change in region 632 and corresponding change in dialect from the first region 629 to the second region 631. In FIG. 6M, the preferred languages 616 include English (U.S.) as the first preferred language 618 and French as the second preferred language. In response to the region 632 of the user changing from the U.S. (e.g., first region 629) to U.K. (e.g., second region 631), the electronic device displays prompt 642 in the settings view. In accordance with a determination that the user is in another English-speaking region with a different dialect (e.g., English U.K.) and English U.K. is not the first preferred language 618 the user, the electronic device optionally prompts the user to designate English U.K. as the first preferred language 618. For example, the prompt 642 includes a message, such as “Would you like English in the U.K. dialect?” In response to receiving a selection of the “yes” affordance 636, the electronic device optionally changes the first preferred language 618 from English U.S. to English U.K. In response to receiving a selection of the “no” affordance 638, the electronic device optionally forgoes changing the first preferred language 618. Instead, the first preferred language 618 optionally remains as it was prior to the electronic device detecting the change in the region 632.

FIGS. 6N to 6P illustrate respective search or other user interfaces in the media playback user interface 602 in response to a user switching between soft keyboards (e.g., on-screen keyboards). FIG. 6N illustrates a search user interface of the media playback user interface 602 including soft keyboard 644 (e.g., keyboard A). The keyboard language 646 of soft keyboard 644 is language A. The soft keyboard 644 has keys with characters included in language A. In some embodiments, the electronic device is configured to recognize text entered via the soft keyboard 644 in accordance with spelling and/or grammatical rules of language A. In some embodiments, the soft keyboard 644 is displayed in response to the electronic device receiving a user input for displaying a keyboard in language A.

FIG. 6O illustrates a soft keyboard 648 in response to receiving user input to switch from the keyboard language A in Fig. N to keyboard language B, where the soft keyboard 648 includes a hint of language B (e.g., 650) a to help the user distinguish between languages A and B of soft keyboards 644 and 648 that are similar in visual appearance, and thereby reducing errors in interaction with the soft keyboards 644 and 648.F Accordingly, FIG. 6O illustrates a search user interface of the media playback user interface 602 including soft keyboard 648 (e.g., keyboard B). The keyboard language 646 of soft keyboard 648 is language B. In accordance with a determination that a visual appearance of the soft keyboard 644 (e.g., keyboard A) is the same as a visual appearance of the soft keyboard 648 (e.g., keyboard B), the electronic device displays a hint of the second language 650 (e.g., name of the second language) on the second soft keyboard or adjacent to the second soft keyboard for a threshold amount of time (e.g., 0.5, 1, 3, 5, 10, 30 seconds, or 1 minute) before disappearing. In FIG. 6O, time scale 652 includes a threshold indicator 654. In some embodiments, the time scale 652 including the threshold indicator 654 is not displayed in the search user interface. And in some embodiments, the time scale 652 including the threshold indicator 654 is displayed in the search user interface. Since the amount of time 656 that has elapsed since the electronic device has received user input to switch to the soft keyboard 648 (e.g., upon initiating display of the hint 650) has not exceeded the amount of time indicated by the threshold indicator 654, the hint 650 is overlaid on the soft keyboard 648 (e.g., keyboard B) in FIG. 6O.

From FIG. 6O to FIG. 6P, the amount of time 656 that has elapsed since initiating display of the hint 650 has exceeded the amount of time indicated by the threshold indicator 654, as illustrated by the time scale 652. Accordingly, in FIG. 6P, soft keyboard 648 (e.g., keyboard B) is now displayed without the hint of language B in the screen view of the media playback user interface 602. In some embodiments, the visual appearance of the soft keyboard 644 is the same as the visual appearance of the soft keyboard 648 in accordance with a determination that more than a threshold percentage (e.g., 20, 30, 50, 60, 90, 95 or 100%) of keys between the soft keyboards 644 and 648 appear the same (e.g., keys of the soft keyboards 644 and 648 being displayed with the same character indications and/or keys with same character indications are located in same positions on respective soft keyboards 644 and 648). In some embodiments, in accordance with a determination that the visual appearances of the soft keyboards 644 and 648 are not the same, the electronic device forgoes displaying the hint of language B on soft keyboard 648 when switching from the soft keyboard 644 to the soft keyboard 648.

FIG. 7 is a flow diagram illustrating a method of displaying subtitles for content items based on language settings in accordance with some embodiments of the disclosure. The method 700 is optionally performed at first and/or electronic devices such as device 100, device 300, or device 500 as described above with reference to FIGS. 1A-1B, 2-3, 4A-4B and 5A-5C. In some embodiments, method 700 is performed at or by an automobile (e.g., at an infotainment system of an automobile having or in communication with one or more display generation components and/or input devices). Some operations in method 700 are, optionally combined and/or order of some operations is, optionally, changed.

As described below, the method 700 provides ways in which the electronic device displays subtitles for content items according to language settings. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 700 is performed at an electronic device, such as device 500 in FIG. 5A, in communication with a display generation component (e.g., 514) and one or more input devices. For example, a mobile device (e.g., a tablet, a smartphone, a media player, or a wearable device), a computer (e.g., a desktop computer, a laptop computer), or a wearable device (e.g., a watch, a head-mounted device), is optionally in communication with one or more of a mouse (e.g., external), trackpad (optionally integrated or external), remote control device (e.g., external), another mobile device (e.g., separate from the electronic device), a handheld device (e.g., external), and/or a controller (e.g., external, etc.), or a set-top box in communication one or more input devices (e.g., a remote control). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc.

In some embodiments, while displaying (e.g., playing) (702a), via the display generation component, a first portion of a content item (e.g., a movie, a television show, or other audio and/or video content) associated with first audio content (e.g., an audio track of the content item), such as portion 606 in FIG. 6A, in accordance with a determination that a first language corresponding to the first audio content of the first portion of the content item, such as current language 614 in FIG. 6A (e.g., the language spoken by one or more actors or subjects in the first portion of the content item, and/or the language spoken by a narrator in the first portion of the content item), does not correspond to a preferred language configured on the electronic device (e.g., a user of the electronic device is able to specify one or more languages as preferred languages on the electronic device, such as with respect to playback of content items; in some embodiments, the user is able to designate one of the preferred languages as a primary language, as will be described later), and that the first audio content satisfies one or more subtitle criteria (702b), the electronic device concurrently displays (702c), via the display generation component, the first portion of the content item and one or more subtitles corresponding to the first audio content, such as subtitles 615 in FIG. 6A (e.g., the one or more subtitles are optionally overlaid on the content item, or displayed adjacent to the content item).

In some embodiments, the one or more subtitles corresponding to the first audio content are in a first preferred language configured on the electronic device, such as first preferred language 618 in FIG. 6A. In some embodiments, the one or more subtitle criteria include a criterion that is satisfied when subtitles corresponding to audio content associated with a currently displayed portion of the content item are available for display (e.g., the electronic device has access to subtitle data for the first audio content of the first portion of the content item, optionally including subtitle data for displaying subtitles in one or more of all of the preferred languages set in the electronic device). In some embodiments, a content item is in a video format such as a movie, a television show, a music video, or an advertisement, or in an audio format such as music or a podcast. The content item is optionally segmented based on time intervals and/or frames. For example, a first portion of the content item optionally includes a certain time interval of the content item (e.g., 0 to 30 seconds of the content item or 0 to 1 minute of the content item) and/or certain number of frames of the content item (e.g., 0 to 900 frames of the content item). Further, a first audio content of the first portion of the content item optionally includes auditory data or sound emitted when a certain time interval and/or frame of a movie, a television show, and the like is reached and/or played. First audio content associated with the first portion of the content item is optionally in a first language. In some embodiments, the electronic device prompts the user to select one or more preferred languages. The one or more preferred languages optionally include one or more of a first preferred language (e.g., primary language), a second preferred language (e.g., a first secondary language), or a third preferred language (e.g., a second secondary language), and so forth. The electronic device optionally separately stores one or more preferred language settings for different users, as will be described in more detail with reference to method 700. If the electronic device does not receive a selection of the one or more preferred languages, as default, the electronic device optionally sets the first preferred language to a language associated with a region in which the electronic device is located (e.g., if the electronic device is located in North America, the electronic device sets the first preferred language to be English), as will be described in more detail with reference to method 700. In some embodiments, before setting the first preferred language to a language associated with a region in which the electronic device is located, the electronic device optionally displays a verification request to the user via the display generation component. In some embodiments, if the first language associated with the first audio content is a preferred language, the electronic device displays the first portion of the content item without subtitles corresponding to the first audio content.

In some embodiments, after displaying the first portion of the content item with the one or more subtitles in the first preferred language, the electronic device displays (e.g., playing) (702d), via the display generation component, a second portion of the content item associated with second audio content (e.g., playback of the content item progresses from the first portion to the second portion), such as portion 608 in FIG. 6B. In some embodiments, a language corresponding to the second audio content is a second language, such as current language 614 in FIG. 6B, different from the first language (e.g., the language spoken by one or more actors or subjects in the second portion of the content item, and/or the language spoken by a narrator in the second portion of the content item is the second language). The second portion is optionally associated with a different time interval and/or different set of frames of the content item than the first portion. For example, the second portion optionally includes a certain time interval and/or frames that are displayed after the first portion of the content item (e.g., 31 to 60 seconds of the content item, or 901 to 1800 frames of the content item). The second portion of the content item is optionally associated with and/or includes second audio content that is different from the first audio content.

In some embodiments, while displaying (e.g., playing) (702e) the second portion of the content item associated with the second audio content, in accordance with a determination that the second audio content satisfies the one or more subtitle criteria (e.g., the electronic device has access to subtitle data for the second audio content of the second portion of the content item, optionally including subtitle data for displaying subtitles in one or more of all of the preferred languages set in the electronic device) and one or more second criteria (7020, including a criterion that is satisfied when the second language is different from the first preferred language, the electronic device displays (702g), via the display generation component, the second portion of the content item without one or more subtitles (e.g. without displaying any subtitles for the second portion of the content item). In some embodiments, the second language corresponds to a preferred language such as a second preferred language. In some embodiments, if the second language corresponds to a non-preferred language (e.g., does not correspond to a preferred language), the electronic device displays the second portion of the content item with subtitles corresponding to the second audio content, wherein the subtitles are in a preferred language. Enabling and/or adjusting subtitles for various portions of a content item according to language preferences of respective users ensures that subtitles are appropriately displayed or not displayed without the need for further input to manually control whether the subtitles are displayed or not displayed.

In some embodiments, a plurality of languages, including the first preferred language, are preferred languages at the electronic device, such as preferred languages 616 in FIG. 6B, and the first preferred language comprises a primary language at the electronic device. In some embodiments, the electronic device presents a prompt to a currently active user via the display generation component (e.g., touchscreen display) to select any number of preferred languages (e.g., 1 preferred language, 3 preferred languages, or 10 preferred languages). For example, a dropdown menu of languages for a first preferred language, a second preferred language, a third preferred language, and so forth is optionally available for selection. In some embodiments, the order of the preferred language indicates a level of proficiency of the currently active user with a respective preferred language. In some embodiments, the electronic device defaults to operating according to the primary language if the relevant function (e.g., subtitles or application localization, as described later) is available in the primary language, and if not, the electronic device instead operates according to a secondary preferred language for the relevant function. Controlling display of subtitles based on various language preferences (e.g., multiple preferred languages) of a user ensures that subtitles are appropriately displayed or not displayed with minimal or no additional input from the user to control the display of subtitles, and thereby enhancing user experience during playback of the content item.

In some embodiments, the second language comprises a second preferred language of the plurality of languages, the second preferred language comprises a secondary language, such as second preferred language 620 in FIG. 6B. In some embodiments, the one or more second criteria include a criterion that is satisfied when the second language is one of the plurality of languages. In some embodiments, the currently active user is more proficient in the first preferred language compared to the second preferred language. In some embodiments, the currently active user is equally proficient in the first preferred language as the second preferred language. In some embodiments, the electronic device is configured with a single primary language, and the remaining one or more preferred languages that are configured on the electronic device are secondary languages. Identifying whether playback of a content item is in a preferred language (e.g., primary language, secondary language) of a user ensures that subtitles are appropriately displayed or not displayed with minimal or no additional input from the user to control the display of subtitles, and thereby enhancing user experience during playback of the content item.

In some embodiments, the first preferred language is associated with a first user associated with the electronic device, such as user 622A in FIG. 6C (e.g., a first user profile configured on the electronic device and/or a first user identified as using, interacting with or otherwise present at the electronic device). In some embodiments, the determination that the first language does not correspond to a preferred language configured on the electronic device is further in accordance with a determination that the first user is currently active at the electronic device (e.g., the first user profile is currently active at the electronic device and/or the electronic device determines that the first user is consuming the content). In some embodiments, the electronic device stores user specific settings (e.g., respective preferred languages) of different users who operate the electronic device. In some embodiments, the electronic device receives login information of the first user, facial recognition information of the first user, or a selection of a profile of the first user, thus indicating that the first user is currently active. In some embodiments, the electronic device (e.g., smart television or set-top box) discovers an input device associated with the first user (e.g., another mobile device separate from the electronic device, such as a smartphone, that is logged into and/or configured with the same user account or profile as the electronic device) via a communication protocol (e.g., Bluetooth, Wi-Fi, or other wireless communication protocol). The presence of the input device (e.g., smartphone) corresponding to the first user optionally indicates that the first user has an active status (e.g., consuming the content displayed by the smart television). In some embodiments, the electronic device determines that the first user is consuming the content based on facial recognition of the first user via the input device (e.g., smartphone or one or more cameras in communication with the electronic device). In some embodiments, the electronic device determines that multiple users are currently active (e.g., consuming the content) at one time, and the electronic device is configured to operate based on respective user specific settings of the multiple users that are currently active (e.g., in one or more of the ways described herein for particular users, concurrently). For example, the electronic device determines that the multiple users are currently active based on discovering respective input devices of the multiple users. Storing language preferences of multiple users ensures subtitles are appropriately displayed or not displayed according to a respective user's language preferences and without input from the respective user to control the display of subtitles, and thereby enhancing user experience of respective users during playback of the content item.

In some embodiments, while displaying (e.g., playing), via the display generation component, the first portion of the content item (e.g., a movie, a television show, or other audio and/or video content) associated with the first audio content, such as audio content of portion 606 illustrated in FIG. 6D (e.g., an audio track of the content item), in accordance with the determination that the first user is currently active at the electronic device (e.g., the electronic device receiving login information of the first user or a selection of a profile of the first user, thus indicating the first user is currently active, or the electronic device otherwise detecting the presence or consumption of the content by the first user), the electronic device concurrently displays, via the display generation component, the first portion of the content item and the one or more subtitles corresponding to the first audio content, such as subtitles 615 in FIG. 6D (e.g., displaying subtitles in a primary language of the first user).

In some embodiments, in accordance with a determination that a second user, different from the first user, such as user 622B in FIG. 6E, is currently active at the electronic device (e.g., the electronic device receiving login information of the second user or a selection of a profile of the second user, thus indicating the second user is currently active, or the electronic device otherwise detecting the presence or consumption of the content by the second user), and in accordance with a determination that that the first language corresponding to the first audio content of the first portion of the content item does not correspond to a preferred language configured on the electronic device for the second user (e.g., preferred languages including the primary language of the first user are optionally different from the second user), the electronic device concurrently displays, via the display generation component, the first portion of the content item and one or more subtitles corresponding to the first audio content, such as subtitles 626 in FIG. 6E. In some embodiments, the one or more subtitles corresponding to the first audio content are in a second preferred language configured on the electronic device for the second user (e.g., displaying subtitles in a primary language of the second user that is optionally different from the primary language of the first user). In some embodiments, if the preferred languages, including the primary language, is the same for the first user and the second user, then the electronic device displays the subtitles in the first preferred language (e.g., primary language of the first user and the second user) for the first portion of the content item. Controlling display of subtitles based on a user's currently active status ensures that subtitles are appropriately displayed or not displayed without additional input from the user to control the display of subtitles, and thereby enhancing user experience of the user during playback of the content item.

In some embodiments, the electronic device receives, via the one or more input devices, a first input corresponding to a request to display a user interface of a first application, such as an input to display the application illustrated in FIG. 6J (e.g., a user launching an application via a mobile device, a computer, or a wearable device. In some embodiments, the first input includes selection of an application icon on a home screen user interface of the electronic device, such as shown in FIG. 4A).

In some embodiments, in response to receiving the first input, in accordance with a determination that localization of the first application in the first preferred language is available (e.g., text, layout, graphics, multimedia, keyboard shortcuts, fonts, character sets, access to remote data or content (e.g., access to streaming content) and/or local data of the application is available for display in the primary language of the user), the electronic device displays, via the display generation component, the user interface of the first application configured for the first preferred language, such as user interface 628 in FIG. 6J (e.g., displaying text, graphics, available remote data or content (e.g., available streaming content) and/or other display data of the application in default localization settings, in the first preferred language), and in accordance with a determination that localization of the first application in the first preferred language is unavailable, the electronic device displays, via the display generation component, the user interface of the first application configured for a second preferred language, different from the first preferred language, such as user interface 630 in FIG. 6J (e.g., updating localization settings for the application such that text, graphics, available remote data or content (e.g., available streaming content) and/or other display data of the application is displayed in another preferred language of the user). Text layout, graphics, multimedia, keyboard shortcuts, fonts, character sets, available remote data or content (e.g., available streaming content) and/or local data of the application is optionally available for display in the secondary language of the user. Automatically launching an application according to a user's language preferences enhances user experience with respect to the application and without a further input to manually control language settings associated with the application.

In some embodiments, while displaying (e.g., playing), via the display generation component, the first portion of the content item (e.g., a movie, a television show, or other audio and/or video content) associated with the first audio content (e.g., an audio track of the content item), such as an audio content of the portion 606 illustrated in FIG. 6G, in accordance with a determination that the first language corresponding to the first audio content of the first portion of the content item does not correspond to a preferred language configured on the electronic device for a first user who is currently active at the electronic device, and in accordance with the determination that the first language corresponding to the first audio content of the first portion of the content item does not correspond to a preferred language configured on the electronic device for a second user, different from the first user, who is currently active at the electronic device, the electronic device concurrently displays, via the display generation component, the first portion of the content item with a first set of subtitles in the first preferred language, such as subtitles 615 in FIG. 6G, associated with the first user (e.g., displaying subtitles in primary language of the first user), and a second set of subtitles in a second preferred language (e.g., displaying subtitles in primary language of the second user different from the first user), different from the first preferred language, such as subtitles 626 in FIG. 6G, associated with the second user (optionally overlaying the first set of subtitles and the second set of subtitles in the same frame or currently displayed portion of the content item (e.g., displaying the first set of subtitles in the left side of a display screen and the second set of subtitles in the right side of the display screen, or vice versa, or displaying the first set of subtitles above the second set of subtitles, or vice versa)). In some embodiments, multiple users (e.g., two users, three users, or five users) are currently active and watching playback of the content item together. In some embodiments, as described in detail with reference to method 700, the electronic device (e.g., smart television) determines that the multiple users are currently active at one time based on discovering respective input devices (e.g., smartphones) of the multiple users via respective communication protocols (e.g., Bluetooth, Wi-Fi, or other wireless communication protocol) and/or via facial recognition. Each of the users optionally has different preferred languages configured on the electronic device, including the primary language. In some embodiments, for each user (e.g., the first user and the second user), the electronic device determines whether relevant functions (e.g., displaying subtitles) are available in the preferred languages of the user (e.g., the first user and the second user), starting from the first preferred language (e.g., primary language). For example, the electronic device optionally defaults to operating according to the primary language of the user if the relevant functions (e.g., displaying the first and second set of subtitles) are available in the primary language. However, if the relevant functions are not available in the primary language, the electronic device optionally determines whether the relevant functions are available in a second preferred language of the user. In accordance with a determination that the relevant functions are available in the second preferred language of the user, the electronic device operates according to the secondary preferred language for the relevant functions (e.g., displaying the first set of subtitles in the second preferred language of the first user). In accordance with a determination that the relevant functions are not available in the second preferred language of the user, the electronic device determines whether the relevant functions are available in a third preferred language of the user. As described above, the electronic device optionally continues to determine whether relevant functions are available for each preferred language of the user (e.g., starting from the first preferred language of the user) until the electronic device determines that relevant functions are indeed available for a certain preferred language of the user. In some embodiments, if the first portion of the content item does correspond to the preferred language of one user (e.g., the first user) but does not correspond to the preferred language of the other user (e.g., the second user), the electronic device displays only one set of subtitles (e.g., the second set of subtitles for the second user). Displaying multiple subtitles in different languages for the same content item enables multiple users with different language preferences to view the same content item simultaneously, thereby enhancing user experience of each of the multiple users during playback of the content item and reducing inputs needed to potentially repeat portions of the content item with different sets of subtitles enabled.

In some embodiments, the first language (e.g., the language spoken by one or more actors or subjects in the first portion of the content item, and/or the language spoken by a narrator in the first portion of the content item) does not correspond to a preferred language configured on the electronic device, and the first audio content satisfies the one or more subtitle criteria, such as a criterion to display the subtitles 615 illustrated in FIG. 6H (e.g., the electronic device has access to subtitle data for the first audio content of the first portion of the content item, optionally including subtitle data for displaying subtitles in one or more of all of the preferred languages set in the electronic device).

In some embodiments, after displaying the one or more subtitles corresponding to the first audio content in the first preferred language, such as subtitles 615 in FIG. 6H, while displaying, via the display generation component, a third portion of the content item associated with third audio content, such as portion 608 in FIG. 6I (e.g., playback of the content item progresses from the first portion to the second portion), in accordance with a determination that a third language corresponding to the third audio content of the third portion of the content item, such as current language 614 in FIG. 6I, does not correspond to a preferred language configured on the electronic device (e.g., the language spoken by one or more actors or subjects in the third portion of the content item, and/or the language spoken by a narrator in the third portion of the content item is the third language), and that the third audio content satisfies the one or more subtitle criteria (e.g., the electronic device has access to subtitle data for the third audio content of the third portion of the content item, optionally including subtitle data for displaying subtitles in one or more of all of the preferred languages set in the electronic device), the electronic device concurrently displays, via the display generation component, the third portion of the content item with one or more subtitles corresponding to the third audio content in the first preferred language, such as subtitles 615 in FIG. 6I (e.g., continue providing subtitles in a primary language of a currently active user despite playback of the content item progressing from the first portion corresponding to a non-preferred language to the third portion corresponding to another non-preferred language). The third portion is optionally associated with a different time interval and/or different set of frames of the content item than the first portion. The third portion of the content item is optionally associated with and/or includes third audio content that is different from the first audio content. In some embodiments, the electronic device defaults to operating according to the primary language if the relevant function (e.g., subtitles) is available in the primary language, and if not, the electronic device instead operates according to a secondary preferred language or another preferred language for the relevant function. Continuing to display subtitles in a preferred language of a user when progressing from a portion of the content item in a non-preferred language to another portion in another non-preferred language eliminates the need for further input to manually control whether the subtitles are displayed, and thereby enhancing user experience during playback of the content item.

In some embodiments, while displaying a respective portion of the content item, in accordance with a determination that respective audio content (e.g., audio track) of the respective portion of the content item (e.g., the first portion, the second portion or a different portion), such as current default audio track language 614 in FIG. 6F, does not correspond to a preferred language configured on the electronic device, the electronic device adjusts the respective audio content of the respective portion of the content item to be the first preferred language, such as current playback audio track language 624 in FIG. 6F (optionally without displaying subtitles for the respective portion of the content item, because the presented language of the respective portion of the content item is now in a preferred language). In some embodiments, playback of certain portions (or all) of the content item includes a dubbed audio track in the primary language of the currently active user. Thus, in some embodiments, the electronic device automatically (e.g., without user input) or in response to receiving a confirmation input from a user (e.g., upon initiating playback of the content item, or upon the current playback position in the content item reaching the respective portion of the content item) changes the audio track of the content item (or the respective portion of the content item) to an audio track in the first-available preferred language of the user. Adjusting (e.g., presenting a dubbed version of) the audio track for various portions of a content item ensures that the audio track meets language preferences of a respective user without the need for further input to change language settings of the content item or inputs or processing resources to display subtitles with the content item, thereby enhancing user experience during playback of the content item.

In some embodiments, the electronic device receives, via the one or more input devices, a first input (e.g., input from a currently active user via a mobile device, computer, or wearable device) corresponding to a request to change a current region setting of the electronic device from a first region to a second region, such as second region 631 in Fig. K (e.g., optionally changing from one country to another country, from one state to another state within a country, or from one continent to another continent). For example, the first input is optionally directed to a language or region settings user interface that is being displayed by the electronic device.

In some embodiments, after receiving the first input, the electronic device changes the current region setting of the electronic device, such as region setting 632 in FIG. 6K, from the first region to the second region, and in accordance with a determination that one or more preferred languages configured at the electronic device include a language associated with the second region (e.g., a language predominantly spoken by people or residents of the second region is different from a language predominantly spoken by people or residents of the first region). In some embodiments, each region is optionally associated with a predefined set of one or more languages. In some embodiments, the language associated with the second region is a preferred language of the user, such as a first preferred language (e.g., primary language) or a second preferred language (e.g., secondary language), the electronic device presents a prompt to designate the language associated with the second region as a primary language at the electronic device, such as prompt 634 in FIG. 6K. For example, the prompt optionally includes displaying a message such as “Would you like to have Spanish as your primary language?” in accordance with a determination that the second region is Spain. In addition to displaying the message, the electronic device optionally displays “yes” and “no” affordances via the touch screen display of the electronic device. In response to receiving a selection of the “yes” affordance, the electronic device optionally changes the first preferred language (e.g., primary language) to the language associated with the second region (e.g., Spanish). In response to receiving a selection of the “no” affordance, the electronic device optionally forgoes changing the first preferred language (e.g., primary language), which optionally remains as it was prior to the electronic device detecting the change in the region.

In some embodiments, after receiving the first input, the electronic device changes the current region setting of the electronic device, such as region setting 632 in FIG. 6L, from the first region to the second region and in accordance with a determination that the one or more preferred languages configured at the electronic device do not include the language associated with the second region, the electronic device presents a prompt to designate the language associated with the second region as a preferred language (optionally primary or secondary) at the electronic device, such as prompt 640 in FIG. 6L. For example, the prompt optionally includes displaying a message such as “Would you like to add Spanish to your preferred languages?” in accordance with a determination that the second region is Spain. In addition to displaying the message, the electronic device optionally displays “yes” and “no” affordances via the touch screen display of the electronic device. In response to receiving a selection of the “yes” affordance, the electronic device optionally adds the language associated with the second region (e.g., Spanish) to the preferred languages of the user (e.g., as a primary language or as a secondary language). In response to receiving a selection of the “no” affordance, the electronic device optionally forgoes adding the preferred languages (e.g., adding or removing languages) of the user. In some embodiments, in response to a change in region of the user, the electronic device presents a prompt to update display frequency of the content item according to the change in region. For example, the prompt optionally includes displaying a message such as “Would you like to change the display frequency to 50 Hz?” in accordance with a determination that the second region is Spain (e.g., where the prior region was the United States, which optionally operates according to a 60 Hz display frequency). In addition to displaying the message, the electronic device optionally displays “yes” and “no” affordances via the touch screen display of the electronic device. In response to receiving a selection of the “yes” affordance, the electronic device optionally changes the display frequency according to the second region (e.g., changing from 60 Hz in U.S. to 50 Hz in Spain). In response to receiving a selection of the “no” affordance, the electronic device optionally forgoes changing the display frequency. In some embodiments, if the electronic device does not receive input designating or configuring one or more preferred languages at the electronic device, as default, the electronic device optionally sets the first preferred language to a language associated with a region in which the electronic device is located (e.g., if the electronic device is located in North America, the electronic device sets the first preferred language to be English). In some embodiments, before setting the first preferred language to a language associated with a region in which the electronic device is located, the electronic device optionally displays a verification request to the user via the display generation component. Presenting a prompt to update a user's preferred languages based on a change in region of a user to account for language changes associated with the change in region ensures that subtitles are appropriately displayed or not displayed without need for further input to manually control language settings of the subtitles, and thereby enhancing user experience during playback of the content item.

In some embodiments, while a primary language at the electronic device is the first preferred language in a first dialect, the electronic device receives, via the one or more input devices, a first input (e.g., input from a currently active user via a mobile device, computer, or wearable device, such as described in more detail with reference to method 700) corresponding to a request to change a current region setting of the electronic device from a first region to a second region, such as second region 631 in Fig. M (optionally changing from regions associated with the same primary language but different dialects (e.g., U.S. vs. U.K. or Mexico vs. Spain).

In some embodiments, after receiving the first input, the electronic device changes the current region setting of the electronic device from the first region to the second region and in accordance with a determination that the second region is associated with the first preferred language in a second dialect (e.g., U.K. English or Spain Spanish), different from the first dialect (e.g., U.S. English vs. Mexico Spanish), the electronic device presents a prompt to designate the first preferred language in the second dialect as the primary language at the electronic device, such as prompt 642 in FIG. 6M. In some embodiments, each region is optionally associated with a predefined set of one or more dialects. In some embodiments, a language in a second dialect associated with the second region is a preferred language of the user, such as a first preferred language (e.g., primary language) or a second preferred language (e.g., secondary language). In some embodiments, in response to changing regions associated with the same primary language but different dialects, the electronic device presents a prompt to update the dialect of the primary language according to the change in region. For example, the prompt optionally includes displaying a message such as “Would you like English in the U.K. dialect?” in accordance with a determination that the region changes from the U.S. to the U.K. In addition to displaying the message, the electronic device optionally displays “yes” and “no” affordances via the touch screen display of the electronic device. In response to receiving a selection of the “yes” affordance, the electronic device optionally changes the primary language according to the dialect of the second region (e.g., U.K. English). In response to receiving a selection of the “no” affordance, the electronic device optionally forgoes changing the primary language. In some embodiments, as default, the electronic device optionally sets the first language in the second dialect as the primary language in response to changing the current region to the second region without prompting the user to designate the first language in the second dialect as the primary language (e.g., automatically setting the primary language as U.K. English when receiving input that the current region has changed to the second region). In some embodiments, before setting the first language in the second dialect as the primary language, the electronic device optionally displays a verification request to the user via the display generation component. Presenting a prompt to update a user's preferred languages based on a change in region of a user to account for dialect changes associated with the change in region ensures that subtitles are appropriately displayed or not displayed without need for further input to manually control language settings of the subtitles, and thereby enhancing user experience during playback of the content item.

In some embodiments, while displaying, via the display generation components, a first soft keyboard (e.g., on screen keyboard on a touch screen display of the electronic device) configured for a first language (e.g., the keyboard includes keys with characters included in the first language and/or the electronic device is configured to recognize text entered via the keyboard in accordance with spelling and/or grammatical rules of the first language), such as soft keyboard 644 in FIG. 6N, the electronic device receives, via the one or more input devices, a first input corresponding to a request to change the first soft keyboard to be configured for a second language, different from the first language, such as keyboard language 646 in FIG. O (e.g., an input selecting the second language, rather than the first language, from a drop-down menu for the keyboard).

In some embodiments, in response to receiving the first input (e.g., input from a currently active user via a mobile device, computer, or wearable device), the electronic device displays, via the display generation component a second soft keyboard (e.g., the same keyboard as the first soft keyboard, or a different keyboard than the first soft keyboard) configured for the second language, such as soft keyboard 648 in FIG. 6N, and a visual indication (e.g., hint) of the second language associated with the second soft keyboard, such as hint 650 in FIG. 6N, overlaid on the second soft keyboard for a threshold duration of time (e.g., 0.5, 1, 3, 5, 10, 30 seconds, or 1 minute). In some embodiments, a hint of the second language (e.g., name of the second language) is overlaid on the second soft keyboard or displayed adjacent to the second soft keyboard for a brief period of time before fading away. In some embodiments, in accordance with a determination that one or more ambiguity criteria are satisfied, including a criterion that is satisfied when a visual appearance of the first soft keyboard is the same as a visual appearance of the second soft keyboard. In some embodiments, the visual appearance of the first soft keyboard is the same as the visual appearance of the second soft keyboard in accordance with a determination that more than a threshold percentage (e.g., 20, 30, 50, 60, 90, 95 or 100%) of keys between the first and second soft keyboards appear the same (e.g., keys of the first and second soft keyboard being displayed with the same character indications and/or keys with same character indications are located in same positions on respective first and second soft keyboards). In some embodiments, if the ambiguity criteria are not satisfied, the electronic device does not display the visual indication of the second language. Displaying a hint of a language associated with a soft keyboard when switching between optionally ambiguous soft keyboards enables a user to easily distinguish between languages of different soft keyboards that are similar in visual appearance, and thereby reducing errors in interaction with the soft keyboards and reducing the need for inputs to correct those errors, thus enhancing user experience when operating the soft keyboards.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., a as described with respect to FIGS. 1A-1B, 3, 5A-5C) or application specific chips. Further, the operations described above with reference to FIG. 7 are, optionally, implemented by components depicted in FIGS. 1A-1B. For example, displaying operations 702a, 702c, 702d, 702e, and 702g are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is the gathering and use of data available from specific and legitimate sources to improve the ability for users to consume content based on language settings that may be of interest to them. The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, content consumption and/or language settings activity can be used to suggest content to a user and display subtitles appropriately for the content. Accordingly, use of such personal information data enables users to use electronic devices in coordinated manners. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of network services, the present technology can be configured to allow users to select to “opt in” or “opt out” of participation in the collection of personal information data during registration for services or anytime thereafter. In another example, users can select not to enable content consumption activity tracking and/or language settings tracking. In addition to providing “opt in” and “opt out” options, the present disclosure contemplates providing notifications relating to the access or use of personal information. For instance, a user may be notified upon initiating content playback and/or receiving preferences for language settings that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content and other user interfaces can be navigated in accordance with the embodiments of the disclosure without tracking the content consumption activity and/or language settings of the user.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device in communication with a display generation component and one or more input devices:
while displaying, via the display generation component, a first portion of a content item associated with first audio content:
in accordance with a determination that a first language corresponding to the first audio content of the first portion of the content item does not correspond to a preferred language configured on the electronic device, and that the first audio content satisfies one or more subtitle criteria, including a criterion that is satisfied when subtitles corresponding to audio content associated with a currently displayed portion of the content item are available for display, concurrently displaying, via the display generation component, the first portion of the content item and one or more subtitles corresponding to the first audio content, wherein the one or more subtitles corresponding to the first audio content are in a first preferred language configured on the electronic device;
after displaying the first portion of the content item with the one or more subtitles in the first preferred language, displaying, via the display generation component, a second portion of the content item associated with second audio content, wherein a language corresponding to the second audio content is a second language, different from the first language; and
while displaying the second portion of the content item associated with the second audio content:
in accordance with a determination that the second audio content satisfies the one or more subtitle criteria and one or more second criteria, including a criterion that is satisfied when the second language is different from the first preferred language, displaying, via the display generation component, the second portion of the content item without one or more subtitles.

2. The method of claim 1, wherein a plurality of languages, including the first preferred language, are preferred languages at the electronic device, and the first preferred language comprises a primary language at the electronic device.

3. The method of claim 2, wherein the second language comprises a second preferred language of the plurality of languages, the second preferred language comprises a secondary language, and the one or more second criteria include a criterion that is satisfied when the second language is one of the plurality of languages.

4. The method of claim 3, wherein the first preferred language is associated with a first user associated with the electronic device, and the determination that the first language does not correspond to a preferred language configured on the electronic device is further in accordance with a determination that the first user is currently active at the electronic device.

5. The method of claim 4, comprising while displaying, via the display generation component, the first portion of the content item associated with the first audio content:
in accordance with the determination that the first user is currently active at the electronic device, concurrently displaying, via the display generation component, the first portion of the content item and the one or more subtitles corresponding to the first audio content; and
in accordance with a determination that a second user, different from the first user, is currently active at the electronic device:
in accordance with a determination that that the first language corresponding to the first audio content of the first portion of the content item does not correspond to a preferred language configured on the electronic device for the second user, concurrently displaying, via the display generation component, the first portion of the content item and one or more subtitles corresponding to the first audio content, wherein the one or more subtitles corresponding to the first audio content are in a second preferred language configured on the electronic device for the second user.

6. The method of claim 1, comprising:
receiving, via the one or more input devices, a first input corresponding to a request to display a user interface of a first application; and
in response to receiving the first input:
in accordance with a determination that localization of the first application in the first preferred language is available, displaying, via the display generation component, the user interface of the first application configured for the first preferred language; and
in accordance with a determination that localization of the first application in the first preferred language is unavailable, displaying, via the display generation component, the user interface of the first application configured for a second preferred language, different from the first preferred language.

7. The method of claim 1, comprising:
while displaying, via the display generation component, the first portion of the content item associated with the first audio content:
in accordance with a determination that the first language corresponding to the first audio content of the first portion of the content item does not correspond to a preferred language configured on the electronic device for a first user who is currently active at the electronic device, and in accordance with the determination that the first language corresponding to the first audio content of the first portion of the content item does not correspond to a preferred language configured on the electronic device for a second user, different from the first user, who is currently active at the electronic device:
concurrently displaying, via the display generation component, the first portion of the content item with a first set of subtitles in the first preferred language associated with the first user, and a second set of subtitles in a second preferred language, different from the first preferred language, associated with the second user.

8. The method of claim 1, wherein the first language does not correspond to a preferred language configured on the electronic device, and the first audio content satisfies the one or more subtitle criteria, the method comprising:
after displaying the one or more subtitles corresponding to the first audio content in the first preferred language, while displaying, via the display generation component, a third portion of the content item associated with third audio content:
in accordance with a determination that a third language corresponding to the third audio content of the third portion of the content item does not correspond to a preferred language configured on the electronic device, and that the third audio content satisfies the one or more subtitle criteria, concurrently displaying, via the display generation component, the third portion of the content item with one or more subtitles corresponding to the third audio content in the first preferred language.

9. The method of claim 1, comprising while displaying a respective portion of the content item:
in accordance with a determination that respective audio content of the respective portion of the content item does not correspond to a preferred language configured on the electronic device, adjusting, via the electronic device, the respective audio content of the respective portion of the content item to be the first preferred language.

10. The method of claim 1, comprising:
receiving, via the one or more input devices, a first input corresponding to a request to change a current region setting of the electronic device from a first region to a second region; and
after receiving the first input, changing the current region setting of the electronic device from the first region to the second region, and:
in accordance with a determination that one or more preferred languages configured at the electronic device include a language associated with the second region presenting a prompt to designate the language associated with the second region as a primary language at the electronic device; and
in accordance with a determination that the one or more preferred languages configured at the electronic device do not include the language associated with the second region, presenting a prompt to designate the language associated with the second region as a preferred language at the electronic device.

11. The method of claim 1, comprising:
while a primary language at the electronic device is the first preferred language in a first dialect, receiving, via the one or more input devices, a first input corresponding to a request to change a current region setting of the electronic device from a first region to a second region; and
after receiving the first input, changing the current region setting of the electronic device from the first region to the second region, and:
in accordance with a determination that the second region is associated with the first preferred language in a second dialect, different from the first dialect presenting a prompt to designate the first preferred language in the second dialect as the primary language at the electronic device.

12. The method of claim 1, comprising:
while displaying, via the display generation components, a first soft keyboard configured for a first language, receiving, via the one or more input devices, a first input corresponding to a request to change the first soft keyboard to be configured for a second language, different from the first language; and
in response to receiving the first input, displaying, via the display generation component:
a second soft keyboard configured for the second language; and
a visual indication of the second language associated with the second soft keyboard overlaid on the second soft keyboard for a threshold duration of time.

13. An electronic device, comprising:
one or more processors;
memory; and
one or more programs, wherein the one or more programs are stored in the memory and configured to be executed by the one or more processors, the one or more programs including instructions for:
while displaying, via a display generation component, a first portion of a content item associated with first audio content:
in accordance with a determination that a first language corresponding to the first audio content of the first portion of the content item does not correspond to a preferred language configured on the electronic device, and that the first audio content satisfies one or more subtitle criteria, including a criterion that is satisfied when subtitles corresponding to audio content associated with a currently displayed portion of the content item are available for display, concurrently displaying, via the display generation component, the first portion of the content item and one or more subtitles corresponding to the first audio content, wherein the one or more subtitles corresponding to the first audio content are in a first preferred language configured on the electronic device;
after displaying the first portion of the content item with the one or more subtitles in the first preferred language, displaying, via the display generation component, a second portion of the content item associated with second audio content, wherein a language corresponding to the second audio content is a second language, different from the first language; and
while displaying the second portion of the content item associated with the second audio content:
in accordance with a determination that the second audio content satisfies the one or more subtitle criteria and one or more second criteria, including a criterion that is satisfied when the second language is different from the first preferred language, displaying, via the display generation component, the second portion of the content item without one or more subtitles.

14. A non-transitory computer readable storage medium storing one or more programs, the one or more programs comprising instructions, which when executed by one or more processors of an electronic device, cause the electronic device to perform a method comprising:
while displaying, via a display generation component, a first portion of a content item associated with first audio content:
in accordance with a determination that a first language corresponding to the first audio content of the first portion of the content item does not correspond to a preferred language configured on the electronic device, and that the first audio content satisfies one or more subtitle criteria, including a criterion that is satisfied when subtitles corresponding to audio content associated with a currently displayed portion of the content item are available for display, concurrently displaying, via the display generation component, the first portion of the content item and one or more subtitles corresponding to the first audio content, wherein the one or more subtitles corresponding to the first audio content are in a first preferred language configured on the electronic device;
after displaying the first portion of the content item with the one or more subtitles in the first preferred language, displaying, via the display generation component, a second portion of the content item associated with second audio content, wherein a language corresponding to the second audio content is a second language, different from the first language; and
while displaying the second portion of the content item associated with the second audio content:
in accordance with a determination that the second audio content satisfies the one or more subtitle criteria and one or more second criteria, including a criterion that is satisfied when the second language is different from the first preferred language, displaying, via the display generation component, the second portion of the content item without one or more subtitles.
